(19) United States
(12) Patent Application Publication
(10) Pub. No.: US 2025/0272805 A1
(43) Pub. Date: Aug. 28, 2025

(54) DISPLAY DEVICE AND IMAGE DISPLAY METHOD THEREFOR

(71) Applicant: Samsung Electronics Co., Ltd., Suwon-si (KR)

(72) Inventors: Jaesung PARK, Suwon-si (KR); Younghoon JEONG, Suwon-si (KR); Youngsu MOON, Suwon-si (KR)

(21) Appl. No.: 19/207,167

(22) Filed: May 13, 2025

Related U.S. Application Data
(63) Continuation of application No. PCT/KR2023/018572, filed on Nov. 17, 2023.

(30) Foreign Application Priority Data
Dec. 28, 2022 (KR) 10-2022-0187962
Dec. 30, 2022 (KR) 10-2022-0190354
Feb. 28, 2023 (KR) 10-2023-0027156
May 19, 2023 (KR) 10-2023-0064893

(51) Int. Cl. G06T 5/73; G06T 5/50; H04N 21/431; H04N 21/485

(52) U.S. Cl. CPC G06T 5/73; G06T 5/50; H04N 21/4312; H04N 21/4854; G06T 2200/24

(57) ABSTRACT

A display device comprises: a display, and at least one processor, comprising processing circuitry, connected to the display and individually and/or collectively, configured to control the display device to: acquire a first image by performing first image quality processing to an input image, based on the input image being received, and acquire a second image by performing second image quality processing to the input image, and display the first image and the second image, and the second image quality processing comprises at least one of planarization processing for the input image, and outline line processing for emphasizing the outline line of an object included in the input image.

### CROSS-REFERENCE TO RELATED APPLICATIONS

This application is a continuation of International Application No. PCT/KR2023/018572 designating the United States, filed on Nov. 17, 2023, in the Korean Intellectual Property Receiving Office and claiming priority to Korean Patent Application Nos. 10-2022-0187962, filed on Dec. 28, 2022, 10-2022-0190354, filed on Dec. 30, 2022, 10-2023-0027156, filed on Feb. 28, 2023, and 10-2023-0064893, filed on May 19, 2023, in the Korean Intellectual Property Office, the disclosures of each of which are incorporated by reference herein in their entireties.

### BACKGROUND

### Field

The disclosure relates to a display device for displaying an image for low-vision users and an image display method therefor.

### Description of Related Art

When users with poor vision or impaired vision watch images, accurately perceiving the images being displayed may be difficult due to vision problems.

Accordingly, various services for raising accessibility for low-vision users to display devices are being provided recently.

### SUMMARY

According to an example embodiment of the disclosure, a display device includes: a display, and at least one processor, comprising processing circuitry, individually and/or collectively, configured to control the display device to: obtain, based on an input image being received, a first image by first image quality processing the input image, and obtain a second image by second image quality processing the input image, and control the display to display the first image and the second image, wherein the second image quality processing includes at least one from among a flattening process with respect to the input image and an outline process for emphasizing outlines of an object included in the input image.

In addition, at least one processor, individually and/or collectively, may be configured to: identify resolutions of the first image and the second image based on boldness of the outlines, and control the display to display the first image and the second image based on the identified resolutions of the first image and the second image.

At least one processor, individually and/or collectively, may be configured to: identify a screen ratio corresponding to the boldness of the outlines from among a plurality of screen ratios that correspond to boldness of a plurality of outlines, and control the display to display the first image and the second image in the display based on the identified screen ratios. In this case, the second image may have a relatively higher resolution than the first image in a screen ratio corresponding to the boldness of the outlines as the boldness of the outlines is higher.

The boldness of the outlines may be set based on a user input, or set based on a distance between a user in a relatively close distance with the display device from among a plurality of users and the display device.

The display device according to an example embodiment may further include a camera, and at least one processor, individually and/or collectively, may be configured to: identify a distance between each of a plurality of users and the display device included in an image captured through the camera, identify a left and right positional relationship of a user positioned at a relatively close distance with the display device from among the plurality of users and the remaining user, and control the display to display the first image and the second image for the left and right positional relationship of the first image and the second image to correspond to the left and right positional relationship between the users, and the first image may be displayed at a position corresponding to the remaining user, and the second image may be displayed at a position corresponding to the user positioned at a relatively close distance with the display device.

The display device according to an example embodiment may further include a camera, and at least one processor, individually and/or collectively, may be configured to: identify, after a plurality of users has been identified from an image captured through the camera, whether any one user from among the plurality of users has moved away from a viewing position based on the captured image, and control, based on any one user from among the plurality of users being identified as having moved away from the viewing position, the display for an image corresponding to the remaining user maintaining the viewing position from among the first image and the second image to be displayed in full screen.

The display device according to an example embodiment may further include a speaker, and at least one processor, individually and/or collectively, may be configured to control the display to: display a graphical user interface (GUI) for selecting one from among the first image and the second image, and output, based on the second image being selected through the GUI according to a user input, a screen commentary audio for the second image through the speaker.

At least one processor, individually and/or collectively, may be configured to control the display to display, based on any one image from among the first image and the second image being transmitted to an external device, the remaining one image from among the first image and the second image in a main screen of a picture in picture (PIP) screen, and control the display for an image transmitted to the external device to be displayed in a sub screen of the PIP screen.

At least one processor, individually and/or collectively, may be configured to control, based on any one image from among the first image and the second image being transmitted to an external device, the display for the remaining one image from among the first image and the second image to be displayed relatively greater than an image transmitted to the external device.

According to an example embodiment of the disclosure, an image display method of a display device includes: obtaining, based on an input image being received, a first image by first image quality processing the input image, and obtaining a second image by second image quality processing the input image, and displaying the first image and the second image, and the second image quality processing includes at least one from among a flattening process with respect to the input image and an outline process for emphasizing the outlines of an object included in the input image.

According to an example embodiment of the disclosure, a non-transitory computer-readable medium storing computer instructions for a display device to perform operations when executed by at least one processor, comprising processing circuitry, individually and/or collectively, of the display device, the operations including: obtaining, based on an input image being received, a first image by first image quality processing the input image, and obtaining a second image by second image quality processing the input image, and displaying the first image and the second image, and the second image quality processing includes at least one from among a flattening process with respect to the input image and an outline process for emphasizing the outlines of an object included in the input image.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A and FIG. 1B are diagrams illustrating a display device according to various embodiments;

FIG. 2A is a block diagram illustrating an example configuration of a display device according to various embodiments;

FIG. 2B is a block diagram illustrating an example configuration of a display device according to various embodiments;

FIG. 3 is a diagram illustrating an example method for generating an output image including a first image and a second image according to various embodiments;

FIG. 4 is a diagram illustrating an example of a menu displayed by a display device according to various embodiments;

FIGS. 5A, 5B, 6A, 6B, 7A, 7B, 8 and 9 are diagrams illustrating an example method for displaying an image by a display device according to various embodiments;

FIG. 10 is a diagram illustrating an example of a menu displayed by a display device according to various embodiments;

FIGS. 11, 12, 13, 14 and 15 are diagrams illustrating an example method for displaying an image by a display device according to various embodiments;

FIG. 16 is a diagram illustrating an example of a menu displayed by a display device according to various embodiments;

FIG. 17 is a diagram illustrating an example method for displaying an image in a horizontal mode and a vertical mode by a display device according to various embodiments;

FIGS. 18, 19A, 19B, 20A, 20B, 20C, 20D, 20E, 21A, 21B, 22A, 22B, 22C and 22D are diagrams illustrating an example method for displaying an image by a display device according to various embodiments; and

FIG. 23 is a flowchart illustrating an example image display method of a display device according to various embodiments.

### DETAILED DESCRIPTION

Various embodiments of the disclosure and terms used herein are not intended to limit the technical features described in the disclosure to specific embodiments, and it is to be understood as including various modifications, equivalents, or alternatives of the corresponding embodiments.

With respect to the description of the drawings, like reference numerals may be used to indicate like or related elements.

A singular form of a noun corresponding to an item may include one or a plurality of items above, unless otherwise specified.

In the disclosure, phrases such as “A or B”, “at least one of A and B”, “at least one of A or B”, “A, B, or C”, “at least one of A, B, and C”, and “at least one of A, B, or C” may respectively include any one or all possible combinations of the items listed together with the relevant phrase from among the phrases. For example, “A or B”, “at least one of A and B”, or “at least one of A or B” may refer to all cases including (1) at least one A, (2) at least one B, or (3) both of at least one A and at least one B.

Terms such as “1st”, “2nd”, or “first” or “second” may be used to simply distinguish a relevant element from another relevant element, and not limit the relevant elements in other aspects (e.g., importance or order).

When a certain (e.g., first) element is indicated as being “coupled with/to” or “connected to” another (e.g., second) element, together with or without terms such as “operatively” or “communicatively”, it may be understood as the certain element being coupled with/to the another element directly (e.g., via wire), wirelessly, or through a third element.

Terms such as “have” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

When a certain element is described as “coupled”, “combined”, “supported”, or “contacted” with another element, the above may include not only the elements being directly coupled, combined, supported, or contacted, but also being indirectly coupled, combined, supported, or contacted through the third element.

When the certain element is described as positioned “on” another element, the above may include not only the certain element being contacted to another element, but also other element being present between the two elements.

The term “and/or” may include a combination of a plurality of related elements described or any element from among the plurality of related elements described.

In certain circumstances, the expression “a device configured to . . . ” may refer, for example, to something that the device “may perform . . . ” together with another device or components. For example, a phrase “a processor configured to (or set up to) perform A, B, or C” may refer, for example, to a dedicated processor for performing a relevant operation (e.g., an embedded processor), or a generic-purpose processor (e.g., a central processing unit (CPU) or an application processor) capable of performing the relevant operations by executing one or more software programs stored in a memory device.

The term “module” or “part” used in the various embodiments herein perform at least one function or operation, and may be implemented with a hardware or software, or implemented with a combination of hardware and software. In addition, a plurality of “modules” or a plurality of “parts,” except for a “module” or a “part” which needs to be implemented with a specific hardware, may be integrated in at least one module and implemented as at least one processor (not shown).

The various elements and regions in the drawings have been schematically illustrated. Accordingly, the technical spirit of the disclosure is not limited by relative sizes and distances illustrated in the accompanied drawings.

Various example embodiments of the disclosure will be described in greater detail below with reference to the accompanied drawings.

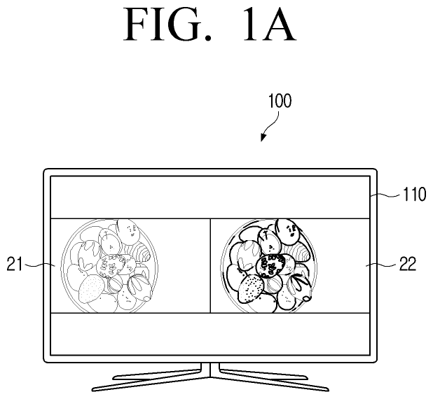

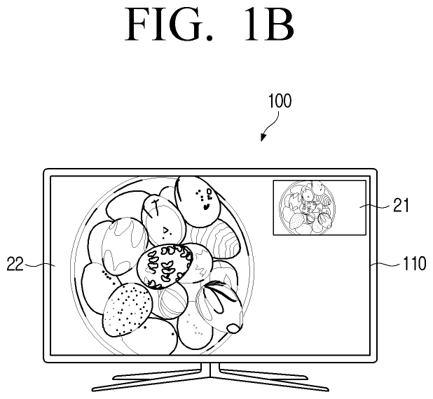

FIG. 1A and FIG. 1B are diagrams illustrating a display device according to various embodiments.

Referring to FIG. 1A and FIG. 1B, a display device 100 may display an image. The image may be configured with a plurality of frames. The image may include various image content such as, for example, and without limitation, a television program, a movie, or a drama provided from an image source in real-time, through a video-on-demand (VOD) service, etc. The image source may include, for example, and without limitation, a terrestrial broadcasting station, a cable broadcasting station, a video streaming service provider, an over-the-top (OTT) service provider, an internet protocol television (IPTV) service provider, and the like that provide image content.

The display device 100 may be implemented with a television (TV). For example, the display device 100 may include, without limitation, a light emitting diode (LED) TV, an organic light emitting diode (OLED) TV, a quantum dot light emitting diode (QLED) TV, a quantum dot (QD) TV, a digital signage device (e.g., an LED display module arranged with one or in a matrix format), etc. In addition, the display device 100 may be a TV having a flat screen, a curved TV having a screen with a fixed curvature, or a curvature variation TV capable of changing curvature.

The display device 100 may operate in one mode from among a horizontal mode and a vertical mode. The horizontal mode may be a mode in which a horizontal length of a display 110 of the display device 100 is longer than a vertical length thereof. In addition, the vertical mode may be a mode in which the vertical length of the display 110 is longer than the horizontal length thereof. The horizontal mode may be referred to as a horizontal direction orientated mode or a landscape mode, and the vertical mode may be referred to as a vertical direction orientated mode or a portrait mode.

According to an example, the display device 100 may rotate the display 110 according to a user input, and operate in one mode from among the horizontal mode or the vertical mode. The user input for rotating the display 110 may, for example, be received from a remote control device (e.g., a user terminal capable of remote control with respect to the display device 100 through applications such as a smartphone and a tablet and/or a remote controller for controlling the display device 100, etc.), or received through a button provided on the display device 100, a user voice, a gesture, and the like. The display device 100 may perform communication with the remote control device through communication methods such as a Wi-Fi communication, a Bluetooth communication, an infrared communication, and the like.

According to an example, the display device 100 may generate a plurality of images by processing an input image, and display the plurality of images on the display 110.

The plurality of images may include a first image 21 and a second image 22. The first image 21 may be an image for general users (e.g., users with normal vision or non-disabled), and the second image 22 may be an image for low-vision users (or people with visual impairment). The display device 100 may simultaneously display the first image 21 for a general user and the second image 22 for a low-vision user. For example, as in FIG. 1A, the display device 100 may display the first image 21 and the second image 22 on the display 110 in a multi-view format. In FIG. 1B, the display device 100 may display the first image 21 and the second image 22 on the display 110 in a picture in picture (PIP) format.

The processing with respect to the input image may include a first image quality processing for obtaining an image for general users and a second image quality processing for obtaining an image for low-vision users.

The first image quality processing may include image quality processing for improving an image quality of an input image.

The second image quality processing may include image quality processing for improving the image quality of the input image and image quality processing for low-vision users to better perceive the image. In general, a person with a visual impairment may have a tendency for preferring detailed expressions inside an object being omitted, and preferring an image with outlines of an object more clearly emphasized. Accordingly, the display device 100 may perform a flattening process with respect to the input image and/or an outline process for emphasizing outlines of an object included in the input image, and obtain the second image 22 for low-vision users by performing image quality processing to improve the image quality with respect to the processed image.

As described above, the display device 100 may obtain the first image 21 for general users and the second image 22 for low-vision users by processing one input image, and display the first image 21 and the second image 22 together. Accordingly, the general user and the low-vision user may view the same image content together, and accessibility to the display device 100 may be improved in light of the low-vision users being provided with image content with improved visibility.

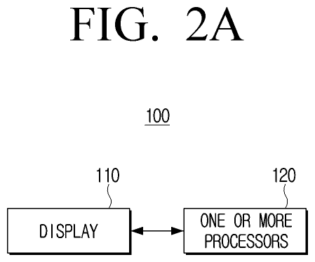

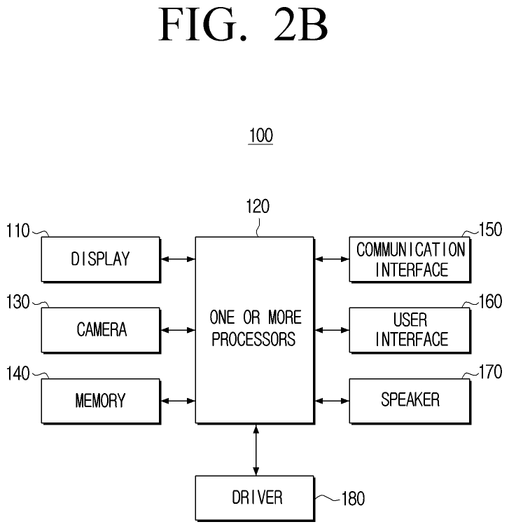

FIG. 2A is a block diagram illustrating an example configuration of a display device according to various embodiments.

Referring to FIG. 2A, the display device 100 may include the display 110 and one or more processors (e.g., including processing circuitry) 120.

The display 110 may display an image. The display 110 may be implemented as a display including self-emissive devices or a display including non-emissive devices and a backlight. For example, the display 110 may be implemented as a display of various types such as, for example, and without limitation, a liquid crystal display (LCD), an organic light emitting diode (OLED) display, a light emitting diode (LED), a micro LED, a mini LED, a plasma display panel (PDP), a quantum dot (QD) display, a quantum dot light emitting diodes (QLED), or the like. In the display 110, a driving circuit, which may be implemented in a form of an a-si TFT, a low temperature poly silicon (LTPS) TFT, an organic TFT (OTFT), or the like, a backlight unit, and the like may be included. In addition, a touch sensor for detecting a touch operation may be disposed at a front surface of the display 110 to detect a touch input. In addition, the display 110 may be implemented as a flat display, a curved display, a flexible display that is foldable and/or rollable, or the like.

The one or more processors 120 may include various processing circuitry and control an overall operation of the display device 100. Specifically, the one or more processors 120 may control the overall operation of the display device 100 by being connected with each configuration of the display device 100. For example, the one or more processors 120 may control the display device 100 by being connected with the display 110. The one or more processors 120 may be configured as one or a plurality of processors.

The one or more processors 120 may perform, by executing one or more instructions stored in a memory of the display device 100, an operation of the display device 100 according to various embodiments of the disclosure.

The one or more processors 120 may include one or more from among a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors 120 may control one or a random combination from among other elements of the display device 100, and perform an operation associated with communication or data processing. The one or more processors 120 may execute one or more programs or instructions stored in the memory. For example, the one or more processors 120 may perform, by executing one or more instructions stored in the memory, a method according to an embodiment of the disclosure.

When a method according to an embodiment of the disclosure includes a plurality of operations, the plurality of operations may be performed by one processor, or performed by a plurality of processors. For example, when a first operation, a second operation, and a third operation are performed by a method according to an embodiment, the first operation, the second operation, and the third operation may all be performed by a first processor, or the first operation and the second operation may be performed by the first processor (e.g., a generic-purpose processor) and the third operation may be performed by a second processor (e.g., an artificial intelligence dedicated processor).

The one or more processors 120 may be implemented as a single core processor that includes one core, or implemented as one or more multicore processors that include a plurality of cores (e.g., a homogeneous multicore or a heterogeneous multicore). If the one or more processors 120 are implemented as multicore processors, each of the plurality of cores included in the multicore processors may include a memory inside the processor such as a cache memory and an on-chip memory, and a common cache shared by the plurality of cores may be included in the multicore processors. In addition, each of the plurality of cores (or a portion from among the plurality of cores) included in the multicore processors may independently read and perform a program command for implementing a method according to an embodiment of the disclosure, or read and perform a program command for implementing a method according to an embodiment of the disclosure due to a whole (or a portion) of the plurality of cores being interconnected.

When a method according to an embodiment of the disclosure includes a plurality of operations, the plurality of operations may be performed by one core from among the plurality of cores or performed by the plurality of cores included in the multicore processors. For example, when a first operation, a second operation, and a third operation are performed by a method according to an embodiment, the first operation, the second operation, and the third operation may all be performed by a first core included in the multicore processors, or the first operation and the second operation may be performed by the first core included in the multicore processors and the third operation may be performed by a second core included in the multicore processors.

In the various embodiments of the disclosure, a processor may refer to a system on chip (SoC), a single core processor, or multicore processors in which one or more processors and other electronic components are integrated or a core included in the single core processor or the multicore processor, and the core herein may be implemented as the CPU, the GPU, the APU, the MIC, the DSP, the NPU, the hardware accelerator, the machine learning accelerator, or the like, but is not limited to the various embodiments of the disclosure. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

For convenience of description below, the one or more processors 120 may be referred to as a processor 120.

FIG. 2B is a block diagram illustrating an example configuration of a display device according to various embodiments.

Referring to FIG. 2B, the display device 100 may include the display 110, the one or more processors (e.g., including processing circuitry) 120, a camera 140, a memory 140, a communication interface (e.g., including communication circuitry) 150, a user interface (e.g., including user interface circuitry) 160, a speaker 170, and a driver (e.g., including various circuitry and/or a motor) 180. However, configurations described above are merely examples, and a new configuration may be added in addition to the configurations as described above or a portion of the configurations may be omitted in implementing the disclosure. Detailed descriptions of configurations that overlap with the configurations shown in FIG. 2A from among the configurations shown in FIG. 2B may not be repeated here.

The camera 130 may be turned-on according to a predetermined event and perform capturing. The camera 130 may convert a captured image into electric signals, and generate image data based on the converted signals. For example, a subject may be converted into electric image signals through a semiconductor charge coupled device (CCD), and the converted image signal as described above may be signal processed after being amplified and converted into digital signals. For example, the camera 130 may be implemented as a regular camera, a stereo camera, a depth camera, or the like.

According to an example, the camera 130 may be disposed at an outer region of the display 110. For example, the camera 130 may be disposed at an upper center, a left center, or a right center bezel region of the display 110, but is not limited to the example described.

The memory 140 may store data necessary for the display device 100 to operate according to various embodiments of the disclosure.

The memory 140 may be implemented as a memory (e.g., a volatile memory, a non-volatile memory, a hard disk drive, a solid state drive, etc.) embedded in the display device 100 according to data storage use, or implemented as a memory (e.g., a memory card, an external memory, etc.) attachable to or detachable from the display device 100.

In addition, the memory 140 may be stored with one or more instructions. In this case, the processor 120 may perform, by executing one or more instructions stored in the memory 140, an operation of the display device 100 according to various embodiments of the disclosure. In addition, the memory 140 may be stored with programs and data for operating the display device 100. Further, the memory 140 may be stored with various software programs and various applications for operating the display device 100.

The communication interface 150 may include circuitry. The communication interface 150 may transmit and receive various information or data with a relevant device by performing communication with various external devices (e.g., an external server, an external device, a remote control device, etc.) according to communication methods of various types.

For example, the communication interface 150 may include a wired LAN communication module such as an Ethernet module. In addition, the communication interface 150 may include wireless communication modules such as, for example, and without limitation, Wi-Fi, Wi-Fi Direct, Bluetooth, Bluetooth Low Energy (BLE), ZigBee, NFC, G-Wave, infrared communication, and the like. In addition, the communication interface 150 may include cellular communication modules such as, for example, and without limitation, 3rd Generation (3G), 3rd Generation Partnership Project (3GPP), Long Term Evolution (LTE), 5th Generation (5G), and the like. In addition, the communication interface 150 may include wired communication modules such as, for example, and without limitation, High-Definition Multimedia Interface (HDMI), Universal Serial Bus (USB), and the like.

According to an example, the processor 120 may include various processing circuitry (as described in detail above) and receive an image from an external server through the internet using the communication interface 150. In addition, the processor 120 may receive an image from an external device (e.g., a set top box) connected through the communication interface 150. In addition, the processor 120 may receive a control command for controlling the display device 100 from the remote control device through the communication interface 150. For example, the remote control device may transmit, based on a user input for controlling the display device 100 being received, a control command corresponding to the user input to the display device 100. The user interface 160 may receive a user input. For example, the user interface 160 may be implemented as a button, a touch pad, a mouse, a keyboard, and the like. In addition, the user interface 160 and the display 110 may be implemented as a touch screen to detect a display function and a touch operation.

The speaker 170 may be a configuration for outputting not only various audio, but also various notification sounds, voice messages, or the like. For example, the processor 120 may convert audio received through the communication interface 150 or audio stored in the memory 140 into audio signals, and output the audio signals through the speaker 170.

The driver 180 may include various circuitry and/or a motor configured to rotate the display 110. For example, the driver 180 may be connected to a gear (e.g., a circular gear) coupled with the display 110, and rotate the display 110 in a clockwise direction or anti-clockwise direction by rotating the gear according to the control of the processor 120. In addition, the driver 180 may stop the rotation of the display 110 by stopping the rotation of the gear according to the control of the processor 120. The driver 180 may include various motors such as, for example, and without limitation, a step motor, a direct current electric motor (DC motor), an alternating current electric motor (AC motor), a brushless DC electric motor (BLDC), and the like.

According to an example, the processor 120 may obtain, based on an input image being received, a first image by first image quality processing the input image and obtain a second image by second image quality processing the input image. Further, the processor 120 may control the display 110 to display the first image and the second image.

The input image may be received from an image source. For example, the image source may include a terrestrial broadcasting station, a cable broadcasting station, a video streaming service provider, an OTT service provider, an IPTV service provider, and the like.

The first image quality processing may include image quality processing for improving the image quality of the input image.

The second image quality processing may include at least one from among the flattening process with respect to the input image and the outline process for emphasizing the outlines of the object included in the input image. For example, the second image quality processing may include image quality processing for improving the image quality of the input image and image quality processing for low-vision users to better perceive the image. For example, the second image quality processing may include the first image quality processing, and additionally, include the flattening process and/or the outline process.

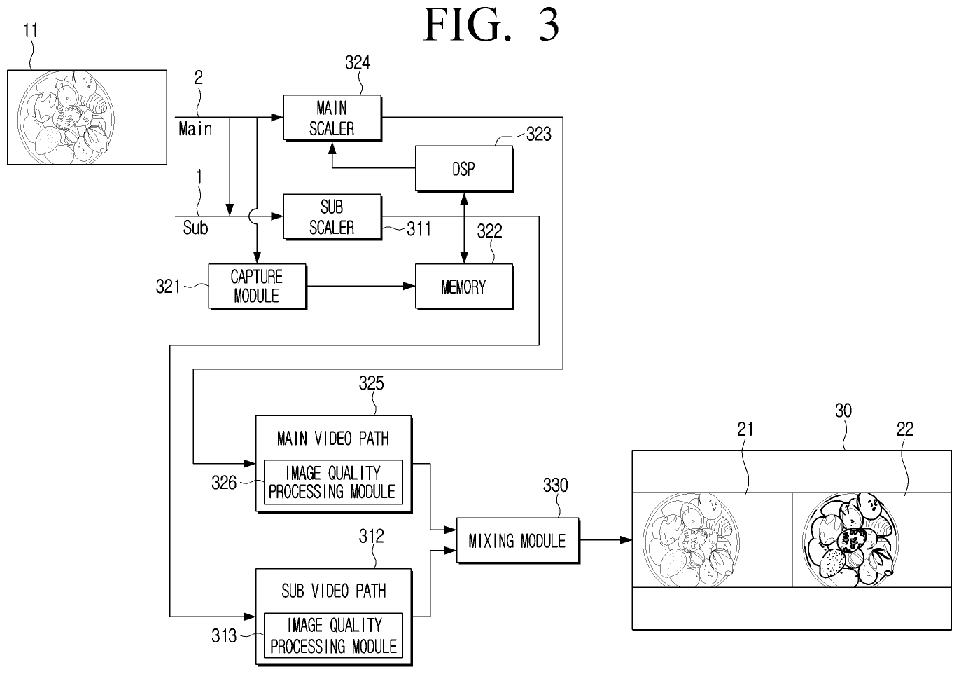

According to an example, as illustrated in FIG. 3, the display device 100 may include two pipelines (or video pipeline), for example, a sub pipeline 1 and a main pipeline 2. The sub pipeline 1 may be a path for generating the first image 21 for the general user by processing an input image 11, and the main pipeline 2 may be a path for generating the second image 22 for the low-vision users by processing the input image 11. The pipelines 1 and 2 may include modules for processing each of the images. The modules may be implemented with hardware or software, or implemented with a combination of hardware and software. The two pipelines 1 and 2 have been designated as the sub pipeline 1 and main pipeline 2, but this is one example, and the two pipelines 1 and 2 may be referred to as a first pipeline 1 and a second pipeline 2.

The processor 120 may input the input image 11 in the main pipeline 2. Then, the input image 11 processed in the sub pipeline I may be provided from the main pipeline 2. For example, in light of the display device 100 generating the first image 21 for general users and the second image 22 for low-vision users by processing one input image 11, the input image input in the main pipeline 2 may not only be processed in the main pipeline 2, but also transferred to the sub pipeline 1 and processed in the sub pipeline 1.

The sub pipeline 1 may generate the first image 21 by performing image quality processing with respect to the input image 11. The sub pipeline 1 may include a sub scaler 311 and a sub video path 312.

The sub scaler 311 may perform scaling of the input image 11 to match the resolution (or size) of the first image 21 displayed on the display 110. The scaling may include up-scaling to correct pixels increasing from a low-resolution image in order to implement a high-resolution image. For example, if the first image 21 is displayed in 4 k (3840×2160) resolution on the display 110, the sub scaler 311 may generate the input image 11 having 4 k resolution by scaling the input image 11. In addition, if the first image 21 is displayed in 8 k (7680×4320) resolution on the display 110, the sub scaler 311 may generate the input image 11 having 8 k resolution by scaling the input image 11. However, the above is one example, and the sub scaler 311 may generate images having various resolutions such as, for example, and without limitation, SD (640×480), HD (1280×720), Full HD (1920×1080), QHD (2560×1440), 4 k, 8 k, and the like according to the resolution of the first image 21 displayed on the display 110.

The sub video path 312 may be a path for generating the first image 21 by performing image quality processing with respect to the scaled image. The sub video path 312 may include an image quality processing module 313. The image quality processing module 313 may adjust a frame rate of an image, and include at least one module for adjusting contrast, color, sharpness, and the like of an image.

The image quality processing module 313 may convert a frame rate of an image. For example, the image quality processing module 313 may convert the frame rate of the image to 120 Hz. In addition, the image quality processing module 313 may remove degradation or noise in an image, and adjust at least one from among contrast, color, color temperature, sharpness, and brightness of an image. However, the above is not limited to this example, and the image quality processing module 313 may perform various processing to improve the image quality of the image.

Through the process as described above, the processor 120 may perform image quality improvement processing with respect to the input image 11, and obtain the first image 21 of a high image quality.

The main pipeline 2 may perform the flattening process and/or the outline process with respect to the input image 11, and generate the second image 22 by performing image quality processing with respect to the processed image. The main pipeline 2 may include a capture module 321, a memory 322, a DSP 323, a main scaler 324, and a main video path 325.

The capture module (e.g., including various circuitry and/or executable program instructions) 321 may capture (or copy) the input image 11, lower the resolution of the captured image through down sampling, and adjust the frame rate of the captured image. For example, the capture module 321 may adjust the resolution of the captured image to have a vertical resolution of 540 p (or, a vertical resolution of less than or equal to 540 p), and adjust the frame rate of the captured image to 30 Hz. As described above, the adjusting the resolution and frame rate of the captured image takes into consideration specifications of the DSP 323. For example, even when the DSP 323 is implemented as a processor with low specifications by lowering the resolution and frame rate of the image processed in the DSP 323, the outline process and/or the flattening process with respect to the image may be effectively performed in the DSP 323.

Images with the resolution and the frame rate adjusted may be stored in the memory 322. The DSP 323 may obtain an image stored in the memory 322, and perform the outline process and/or the flattening process with respect to the obtained image.

The outline process may refer, for example, to emphasizing the outlines by displaying a thickness of an outline of an object more thickly or processing a color of the outline in a specific color. For example, the DSP 323 may detect outlines of objects in an image. Then, the DSP 323 may adjust the thickness and color of the outlines according to outline parameters. The outline parameter may include the boldness and color of the outlines. The boldness of the outline may include a degree of thickness and/or a degree of darkness of the outlines. The outlines may be more thickly and more darkly adjusted in case the boldness of the outlines is higher. The DSP 323 may adjust the thickness and color of the outlines according to the outline parameters, and overlay the adjusted outlines on the image.

The flattening process may refer, for example, to a process of eliminating details inside of an object. The DSP 323 may perform the flattening process by removing textures or detailed expressions inside objects included in the image. Accordingly, the inside of the objects may be processed so as to be blurred or crushed.

The main scaler 324 may perform scaling of the input image which has been performed with the flattening process and/or the outline process to match the resolution of the second image 22 displayed on the display 110. The scaling may include up-scaling to correct pixels increasing from a low-resolution image in order to implement a high-resolution image. For example, if the second image 22 is displayed in 4 k resolution on the display 110, the main scaler 324 may generate an image having 4 k resolution by scaling the image performed with the flattening process and/or the outline process. In addition, if the second image 22 is displayed in 8 k resolution on the display 110, the main scaler 324 may generate an image having 8 k resolution by scaling the image performed with the flattening process and/or the outline process. However, the above is one example, and the main scaler 324 may generate images having various resolutions such as, for example, and without limitation, SD, HD, Full HD, QHD, 4 k, 8 k, and the like according to the resolution of the second image 22 displayed on the display 110.

The main video path 325 may be a path for generating the second image 22 by performing image quality processing with respect to a scaled image. The main video path 325 may include an image quality processing module 326. The image quality processing module 326 may adjust a frame rate of an image, and include at least one module for adjusting the contrast, color, sharpness, and the like of an image.

The image quality processing module 326 may include various circuitry and/or executable program instructions and convert a frame rate of an image. For example, the image quality processing module 326 may convert the frame rate of the image to 120 Hz. In addition, the image quality processing module 326 may remove degradation or noise in an image, and adjust at least one from among contrast, color, color temperature, sharpness, and brightness of an image. However, the above is not limited to this example, and the image quality processing module 326 may perform various processing to improve the image quality of the image.

The image quality processing module 326 may perform image quality processing based on the boldness and color of the outlines. For example, the image quality processing module 326 may determine a setting value corresponding to the boldness and color of the outlines from among a plurality of setting values for image quality processing, and adjust the contrast, the color, the color temperature, the sharpness, and the brightness of the image using an image quality adjusting function corresponding to the determined setting value. Accordingly, image quality processing with respect to an image may be performed to have thicker and darker color outlines in case of the boldness of the outlines being higher.

Through the process described above, the processor 120 may perform the flattening process and/or the outline process with respect to the input image 11, and obtain the second image 22 of a high image quality by performing the image quality improvement processing.

According to an example, processing for image quality improvement of an image may be performed using an artificial intelligence (AI) model. The artificial intelligence model may be configured with a machine learning (deep learning) and element techniques utilizing the machine learning. AI techniques may be implemented utilizing algorithms. An algorithm for implementing the artificial intelligence model or a set of algorithms may be referred to as a neural network. The neural network may receive input data, perform computations for analysis and classification, and output result data. As described above, at least one processor may execute program instructions to achieve or perform various functions and may include a neural network. Likewise, at least one model may include a combination of circuitry and/or processors performing various of the recited/disclosed functions, e.g., in a distributed manner using, for example, a neural network. At least one processor and/or model may execute program instructions to achieve or perform various functions.

The processor 120 may perform mixing (or multiplexing) of the first image 21 and the second image 22 using a mixing module 330, and generate an output image 30 including the first image 21 and the second image 22. For example, the mixing module 330 may generate the output image 30 by mixing the first image 21 and the second image 22 for the first image 21 and the second image 22 to be displayed in a multi-view or PIP format on the display 110. The processor 120 may display the output image 30 on the display 110. Accordingly, the first image 21 and the second image 22 may be displayed together on the display 110.

According to an example, the processor 120 may display, based on a simultaneous viewing function (or a simultaneous viewing mode) being activated (or turned-on), the first image 21 and the second image 22 on the display 110.

The simultaneous viewing function may refer, for example, to a function which allows general users and low-vision users to view the same image content together.

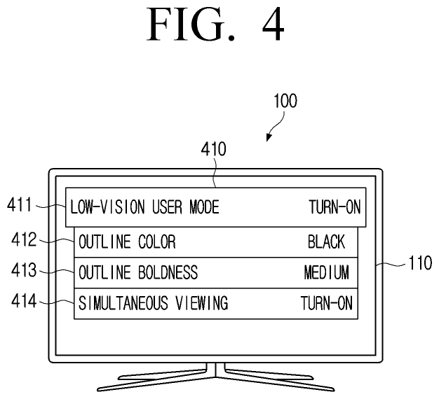

For example, as illustrated in FIG. 4, the processor 120 may display a menu 410 (e.g., an on screen display (OSD) menu) for low-vision users on the display 110. The processor 120 may activate (or turn-on) a low-vision user mode when a user input for selecting a low-vision user mode 411 (or may be referred to as a Relumino mode) is received through the menu 410. The low-vision user mode may be a mode for displaying the second image 22 for low-vision users. Further, the processor 120 may display various sub menus 412, 413, and 414 on the display 110. The sub menus 412 and 413 may be menus for setting outline parameters. A user may set the color and boldness of the outlines through the sub menus 412 and 413. The boldness of the outlines may include a plurality of levels (e.g., strong/medium/weak). The colors of the outlines may include black and green colors. However, the above is one example, and the colors of the outlines may include various colors. The processor 120 may determine the boldness and color of the outlines according to outline parameters set through the sub menus 412 and 413, adjust the outlines according to the determined boldness and color, and generate the second image 22 by overlaying the adjusted outlines over the input image 11. In addition, the sub menu 414 may be a menu for turning-on or turning-off the simultaneous viewing function. The processor 120 may turn-on or turn-off the simultaneous viewing function based on a user input received through the sub menu 414.

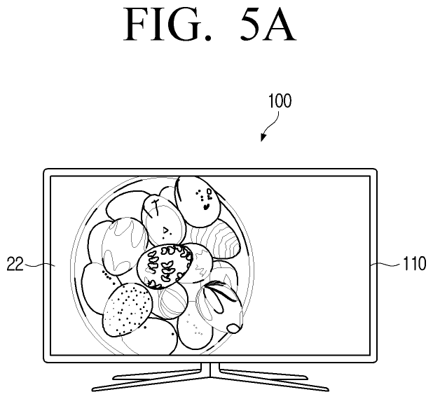

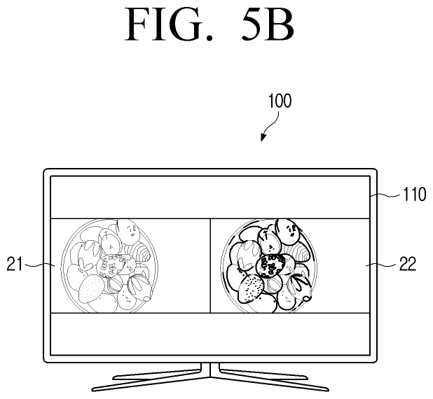

For example, as illustrated in FIG. 5A, the processor 120 may control, based on the display device 100 operating in the low-vision user mode, and the simultaneous viewing function being turned-off, the display 110 to display the second image 22. The second image 22 may be displayed in full screen of the display 110. For example, the processor 120 may generate the second image 22 by processing the input image 11 through the main pipeline 2, and display the second image 22 in full screen on the display 110. In this case, the input image 11 may not be processed through the sub pipeline 1.

In addition, as illustrated in FIG. 5B, the processor 120 may control, based on the display device 100 operating in the low-vision user mode, and the simultaneous viewing function being activated, the display 110 to display the first image 21 and the second image 22. For example, the processor 120 may generate the first image 21 by processing the input image 11 through the sub pipeline 1, generate the second image 22 by processing the input image 11 through the main pipeline 2, and display the first image 21 and the second image 22 on the display 110.

According to an example, the processor 120 may display, based on a user input for turning-on the simultaneous viewing function being received, a menu for selecting a screen ratio between the first image 21 and the second image 22 on the display 110. The screen ratio between the first image 21 and the second image 22 may refer, for example, to a ratio for screen sizes between the first image 21 and the second image 22 displayed together on the display 110 due to the simultaneous viewing function. For example, the processor 120 may display a menu for selecting one from among 1:1, 1:2, and 1:3 as the screen ratio between the first image 21 and the second image 22 on the display 110. However, the above is not limited to this example, and the screen ratio between the first image 21 and the second image 22 may be selected from among 1:1, 1:2, 1:3, 1:4, 1:5, and the like.

The processor 120 may determine the resolutions of the first image 21 and the second image 22 based on the screen ratio selected according to the user input, generate the first image 21 and the second image 22 based on the determined resolution, and display the first image 21 and the second image 22 on the display 110.

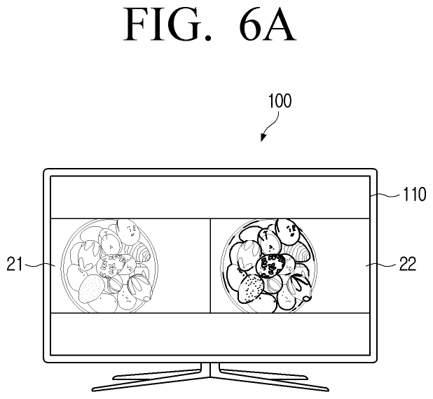

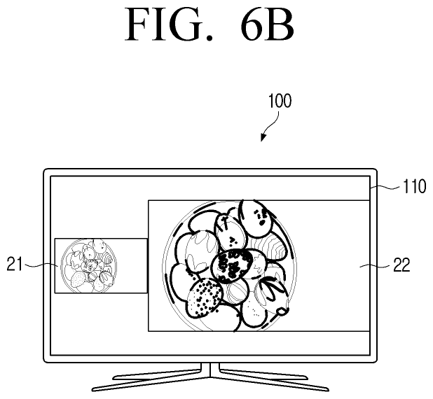

For example, it may be assumed that the display 110 has a resolution of 7680×4320. The processor 120 may display, based on the screen ratio between the first image 21 and the second image 22 being selected as 1:1, the first image 21 having a resolution of 3840×2160 and the second image 22 having a resolution of 3840×2160 on the display 110 as illustrated in FIG. 6A. In addition, the processor 120 may display, based on the screen ratio between the first image 21 and the second image 22 being selected as 1:2, the first image 21 having a resolution of 2560×1440 and the second image 22 having a resolution of 5120×2880 on the display 110.

In the above-described example, the boldness of the outlines has been described as being set based on the user input, but the above is not limited to this example. For example, the boldness of the outlines may be set based on a distance between a user in a relatively close distance with the display device 100 from among a plurality of users and the display device 100. The plurality of users may be two users, but is not limited to this example.

The processor 120 may identify a distance between each of the plurality of users and the display device 100 included in an image captured through the camera 130. For example, the processor 120 may identify, based on the camera 130 being implemented as a stereo camera or a depth camera, the plurality of users from the image captured by the camera 130, and identify the distance between each of the plurality of users and the display device 100. The distance with the user may be identified by other sensors (e.g., a distance sensor) in addition thereto. However, the above is not limited to this example, and it may be implemented such that the distance between the display device 100 and the user is set directly by the user. For example, the user may select a distance through a menu displayed on the display device 100, or set a distance with the display device 100 using buttons and the like for each distance provided in the remote control device.

The processor 120 may identify a user positioned at a relatively close distance with the display device 100 from among the plurality of users, and identify the boldness of the outlines based on a distance (hereinafter, referred to as a viewing distance) between the identified user and the display device 100. For example, the processor 120 may identify, based on a viewing distance being greater than a predetermined value, the boldness of the outlines as being a first level, and identify, based on the viewing distance being less than or equal to the predetermined value, the boldness of the outlines as being a second level. For example, the predetermined value may be 1 m. The first level may be weak, and the second level may be strong or medium. The first level may be weak or medium, and the second level may be strong.

In the above-described example, although it has been described as the boldness of the outlines being set to the first level or the second level according to the viewing distance, the above is not limited to this example. The boldness of the outlines may be divided into a first level, a second level, and a third level according to the viewing distance. The first level may be weak, the second level may be medium, and the third level may be strong. For example, the processor 120 may identify, based on the viewing distance being less than or equal to a first predetermined value, the boldness of the outline as the third level, identify, based on the viewing distance being greater than the first predetermined value and less than or equal to a second predetermined value, the boldness of the outline as the second level, and identify, based on the viewing distance being greater than the second predetermined value, the boldness of the outline as the first level. For example, the first predetermined value may be 1 m, and the second predetermined value may be 2 m.

As described above, the boldness of the outlines may be set according to the viewing distance. For example, if a plurality of images is displayed on the display device 100 according to the simultaneous viewing function, the users relatively close to the display device 100 from among the plurality of users viewing the plurality of images are highly likely to correspond to the low-vision users. In addition, the low-vision users are highly likely to view an image at a position close to the display device 100 the worse their visions are. Accordingly, according to an example, as the viewing distance of the low-vision users is shorter, the boldness of the outlines may be set high increasing the visibility of images for low-vision users and thereby, assist in the image viewing of low-vision users.

In the above-described example, the screen ratio has been described as being set based on the user input, but the above is not limited to this example. For example, the screen ratio between the first image 21 and the second image 22 may be set automatically based on the boldness of the outlines.

According to an example, the processor 120 may identify the resolutions of the first image 21 and the second image 22 based on the boldness of the outlines. The boldness of the outlines may be set based on a user input, or set based on the distance between the user in a relatively close distance with the display device 100 from among the plurality of users and the display device 100. The processor 120 may control the display 110 to display the first image 21 and the second image 22 based on the identified resolutions of the first image 21 and the second image 22.

The processor 120 may identify the screen ratio corresponding to the boldness of the outlines from among a plurality of screen ratios that correspond to boldness of a plurality of outlines, and display the first image 21 and the second image 22 on the display 110 based on the identified screen ratio. In this case, the second image 22 may have a relatively higher resolution than the first image 21 in the screen ratio corresponding to the boldness of the outline in case of the boldness of the outlines being higher.

For example, the plurality of screen ratios may include 1:1, 1:2, and 1:3. The processor may identify, based on the boldness of the outlines being the first level, the screen ratio between the first image 21 and the second image 22 as 1:1, identify, based on the boldness of the outlines being the second level, the screen ratio between the first image 21 and the second image 22 as 1:2, and identify, based on the boldness of the outlines being the third level, the screen ratio between the first image 21 and the second image 22 as 1:3. For example, the first level may be weak, the second level may be medium, and the third level maybe strong. In the above-described example, the plurality of screen ratios has been described as including 1:1, 1:2, and 1:3, but the above is not limited to this example. For example, the plurality of screen ratios may include 1:1, 1:2, 1:3, 1:4, 1:5, and the like.

The processor 120 may display the first image 21 and the second image 22 on the display 110 based on the identified screen ratio. For example, the processor 120 may set, based on the screen ratio not being set, the screen ratio identified based on the boldness of the outlines as the screen ratio between the first image 21 and the second image 22. In addition, the processor 120 may change, based on the screen ratio being pre-set, the screen ratio which was previously set to the screen ratio identified based on the boldness of the outlines. Then, the processor 120 may generate the first image 21 and the second image 22 based on the screen ratio, and display the first image 21 and the second image 22 on the display 110.

For example, it may be assumed that the boldness of the outlines is set to weak according to the user input. In this case, the processor 120 may set the screen ratio to 1:1 based on the boldness of the outlines. As illustrated in FIG. 6A, the processor 120 may display, based on the simultaneous viewing function being turned-on, the first image 21 having a resolution of 3840×2160 and the second image 22 having a resolution of 3840×2160 on the display 110. In another example, it may be assumed that the boldness of the outlines is set to medium according to the user input. In this case, the processor 120 may set the screen ratio to 1:2 based on the boldness of the outlines. As illustrated in FIG. 6B, the processor 120 may display, based on the simultaneous viewing function being turned-on, the first image 21 having a resolution of 2560×1440 and the second image 22 having a resolution of 5120×2880 on the display 110.

As described above, a resolution of an image for low-vision users may be adjusted according to the boldness of outlines. For example, in case of simultaneous viewing, an image for general users and an image for low-vision users may be displayed together. In this case, in light of the image for low-vision users being displayed in a smaller size than when displayed in full screen, an effect of visibility increasing for low-vision users may be minimal. The low-vision user may be more likely to set the boldness of the outlines to high the worse their vision is. Accordingly, according to an example, as the boldness of the outlines is set higher, the image for low-vision users may be displayed larger increasing the visibility of the image and thereby, assist in the image viewing of low-vision users.

In the above-described example, the boldness of the outlines has been described as being set based on the user input or the viewing distance, but the above is not limited to this example. For example, the boldness of the outlines may be set automatically based on the screen ratio between the first image 21 and the second image 22.

According to an example, the processor 120 may identify the boldness corresponding to the screen ratio set based on the user input from among a plurality of boldness that corresponds to the plurality of screen ratios, generate the second image 22 based on the identified boldness, and display the first image 21 and the second image 22 on the display 110. In this case, based on it being a screen ratio with the second image 22 having a relatively higher resolution than the first image 21, the boldness of the outlines corresponding thereto may be relatively high.

For example, the processor 120 may identify, based on the screen ratio between the first image 21 and the second image 22 being 1:1, the boldness of outlines as the first level, identify, based on the screen ratio between the first image 21 and the second image 22 being 1:2, the boldness of outlines as the second level, and identify, based on the screen ratio between the first image 21 and the second image 22 being 1:3, the boldness of outlines as the third level. For example, the first level may be weak, the second level may be medium, and the third level may be strong.

The processor 120 may generate the second image 22 based on the identified boldness of outlines. For example, the processor 120 may set, based on the boldness of outlines not being set, the level identified based on the screen ratio as the boldness of outlines. In addition, the processor 120 may change, based on the boldness of outlines being pre-set, the boldness which was previously set as the identified level based on the screen ratio. Further, the processor 120 may generate the second image 22 based on the boldness of outlines, and display the first image 21 and the second image 22 on the display 110.

For example, it may be assumed that the screen ratio between the first image 21 and the second image 22 is set to 1:1 according to the user input. In this case, the processor 120 may set the boldness of outlines to weak based on the screen ratio. Further, as in FIG. 6A, the processor 120 may display, based on the simultaneous viewing function being turned-on, the first image 21 having a resolution of 3840×2160 and the second image 22 having a resolution of 3840×2160 on the display 110. In another example, it may be assumed that the screen ratio between the first image 21 and the second image 22 is set to 1:2 according to the user input. In this case, the processor 120 may set the boldness of outlines to medium based on the screen ratio. Then, as in FIG. 6B, the processor 120 may display, based on the simultaneous viewing function being turned-on, the first image 21 having a resolution of 2560×1440 and the second image 22 having a resolution of 5120×2880 on the display 110.

As described above, the boldness of outlines may be adjusted according to the screen ratio between the first image 21 and the second image 22. For example, it may be highly likely that the image for low-vision users are set, by the user, to be displayed relatively larger than the image for general users the worse the vision of the low-vision users are. Accordingly, according to an example, as the size of the image for low-vision users are set larger, the boldness of outlines may be set high increasing the visibility of the image and thereby, assist in the image viewing of low-vision users.

The screen ratio between the first image 21 and the second image 22 may be set based on the viewing distance. The processor 120 may identify, based on the viewing distance being greater than the predetermined value, the screen ratio between the first image 21 and the second image 22 as 1:1, and identify, based on the viewing distance being less than or equal to the predetermined value, the screen ratio between the first image 21 and the second image 22 is a screen ratio (e.g., 1:2, 1:3, etc.) with the second image 22 having a higher resolution than the first image 21. For example, the predetermined value may be 1 m.

According to an example, the processor 120 may identify a distance between each of the plurality of users and the display device 100 included in an image captured through the camera 130, and identify a left and right positional relationship of a user positioned at a relatively close distance with the display device 100 from among the plurality of users and the remaining user. The left and right positional relationship may refer, for example, to which of the user is positioned at a left side from and which of the user is positioned at the right side the front surface of the display device 100. For example, the processor 120 may identify which user is positioned at relatively left side and which user is positioned at a relatively right side by identifying the relative left and right positional relationship of the user positioned at a relatively close distance with the display device 100 and the remaining user based on the image captured through the camera 130.

The processor 120 may control the display 110 to display the first image 21 and the second image 22 such that the left and right positional relationship of the first image 21 and the second image 22 corresponds to the left and right positional relationship between the users. The first image 21 may be displayed at a position corresponding to the remaining user, and the second image may be displayed at a position corresponding to the user in a relatively close distance with the display device 100. The displaying the image so as to correspond may refer, for example, to displaying an image at the left side for the user positioned at the left side, and displaying an image at the right side for the user positioned at the right side.

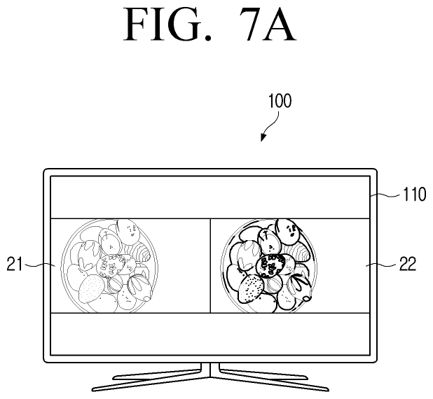

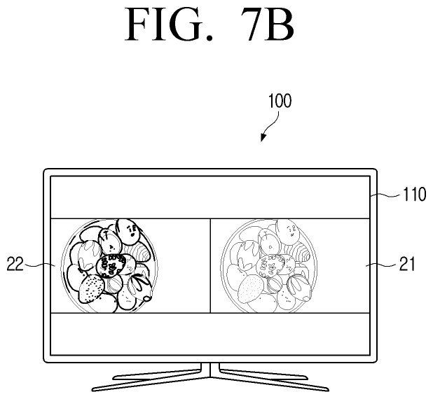

For example, as illustrated in FIG. 7A, the processor 120 may identify, based on the user positioned at a relatively close distance with the display device 100 being positioned at the left side and the remaining user being positioned at the right side, the second image 22 as being disposed at the left side of the first image 21, and control the display 110 to display the first image 21 and the second image 22 according to the identified positions. In addition, as illustrated in FIG. 7B, the processor 120 may identify, based on the user positioned at a relatively close distance with the display device 100 being positioned at the right side and the remaining user being positioned at the left side, the second image 22 as being disposed at the right side of the first image 21, and control the display 110 to display the first image 21 and the second image 22 according to the identified positions.

The processor 120 may identify whether the left and right positions between the users is changed by tracking the plurality of users using the image captured through the camera 130. The processor 120 may change, based on identifying that the left and right positions of the users has been changed, the left and right positons of the first image 21 and the second image 22 to correspond to the changed left and right positions, and control the display 110 to display the first image 21 and the second image 22 according to the changed positions.

For example, it may be assumed that the user positioned at a relatively close distance with the display device 100 is positioned at the left side and the remaining user is positioned at the right side. The processor 120 may control, based on identifying that the left and right positions between the users is changed and that the user positioned at a relatively close distance with the display device 100 is positioned at the right side and the remaining user is positioned at the left side, the display 110 for the second image 22 to be displayed at the right side of the first image 21 by changing the left and right positions of the first image 21 and the second image 22. It may be assumed that the user positioned at a relatively close distance with the display device 100 is positioned at the right side and the remaining user is positioned at the left side. The processor 120 may control, based on identifying that the left and right positional relationship between the users is changed and that the user positioned at a relatively close distance with the display device 100 is positioned at the left side and the remaining user is positioned at the right side, the display 110 for the second image 22 to be displayed at the left side of the first image 21 by changing the left and right positions of the first image 21 and the second image 22.

In the above-described example, the positions at which the first image 21 and the second image 22 are displayed have been described as being determined according to the left and right positional relationship of the users, but the above is not limited to this example. The processor 120 may change display positions of the first image 21 and the second image 22 according to a user input. For example, if a specific button of the remote control device is selected by the user, the remote control device may transmit a control command for changing the display positions of the first image 21 and the second image 22 to the display device 100. The processor 120 may dispose the second image 22 at the right side or the left side of the first image 21 based on the received control command.

As described, the positions at which the first image and the second image are displayed may be determined according to the left and right positional relationship of the users. For example, if a plurality of images is displayed on the display device 100 according to the simultaneous viewing function, it may be highly likely that the user relatively close to the display device 100 from among the plurality of users viewing the plurality of images corresponds to the low-vision user. Accordingly, according to an example, assistance may be provided for the image viewing of low-vision users by disposing an image for low-vision users in front of the low-vision user according to the position of the low-vision user.

According to an example, the processor 120 may identify, after identifying a plurality of users in an image captured through the camera 130, whether any one user from among the plurality of users has moved away from the viewing position based on the captured image. The viewing position may refer, for example, to a position at which a user can view an image displayed on the display device 100. The processor 120 may identify a user from an image captured through the camera 130, and identify whether the user has moved away from the viewing position by tracking the user. For example, the processor 120 may identify, based on a user included in an image captured by the camera 130 not being captured by the camera 130 any longer, or the user being identified as being apart by greater than or equal to a predetermined distance from the display device 100, the user as having moved away from the viewing position.

The processor 120 may control, based on any one user from among the plurality of users being identified as having moved away from the viewing position, the display 110 for an image corresponding to the remaining user maintaining the viewing position from among the first image 21 and the second image 22 to be displayed in full screen. The processor 120 may control, based on identifying that the user who moved away from the viewing position has returned back to the viewing position, the display 100 to display the first image 21 and the second image 22. For example, the processor 120 may detect a face region of the user in the image captured by the camera 130, distinguish the user using a feature vector of the face region, and identify whether the user who moved away from the viewing position has returned back to the viewing position.

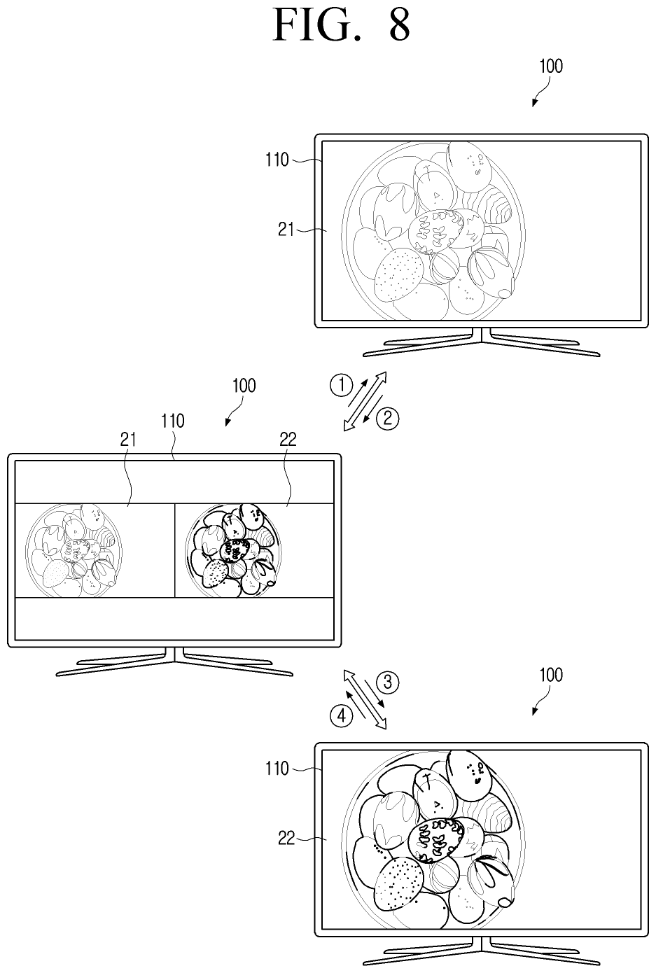

For example, as illustrated in FIG. 8, it may be assumed that the first image 21 and the second image 22 are displayed on the display 110. The processor 120 may display, based on identifying that the user positioned at a relatively far distance from the display device 100 from among the plurality of users has moved away from the viewing position, the first image 21 in full screen of the display 110 \textcircled{1} of FIG. 8). Then, the processor 120 may display, based on identifying that the user has returned back to the viewing position, the first image 21 and the second image 22 on the display 110 (\textcircled{2} of FIG. 8). In addition, the processor 120 may display, based on identifying that the user positioned at a relatively close distance with the display device 100 has moved away from the viewing position, the second image 22 in full screen of the display 110 (\textcircled{3} of FIG. 8). Then, the processor 120 may display, based on identifying that the user has returned back to the viewing position, the first image 21 and the second image 22 on the display 110 (\textcircled{4} of FIG. 8).

As described above, even when the simultaneous viewing function is provided, if the user moves away from the viewing position, the image for the user remaining at the viewing position may be displayed in full screen. Accordingly, according to an example, in case of the low-vision user remaining at the viewing position, the image for the low-vision user may be displayed in full screen, and assistance may be provided for the image viewing of low-vision users in light of the visibility of the image for low-vision users being increased.

According to an example, the processor 120 may control the display 110 to display a graphical user interface (GUI) for selecting one from among the first image 21 and the second image 22. For example, the processor 120 may display the GUI using various methods such as displaying the outline portion of the image in a different color, displaying by highlighting the image, adding specific images such as an arrow, a cursor, and an indicator, and the like. The GUI may be moved according to a user input, and the image at which the GUI is positioned from among the first image 21 and the second image 22 may be selected.

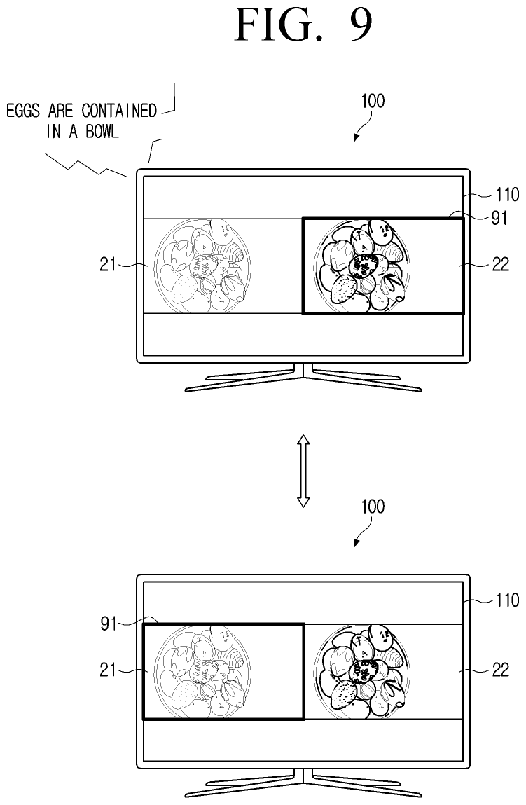

The processor 120 may output, based on the second image 22 being selected through the GUI according to a user input, a screen commentary audio for the second image 22 through the speaker 170. The screen commentary audio may refer, for example, to a voice for describing motions, clothing, various situations, and the like of people included in an image to the user with a visual impairment. For example, if the second image 22 is selected, the screen commentary audio in addition to audio content on the image may be additionally output through the speaker 170. For example, as illustrated in FIG. 9, the processor 120 may output, based on the second image 22 being selected through a GUI 91, the screen commentary audio (e.g., the eggs are contained in a bowl) through the speaker 170. However, if the first image 21 is selected through the GUI 91, the screen commentary audio may not be output.

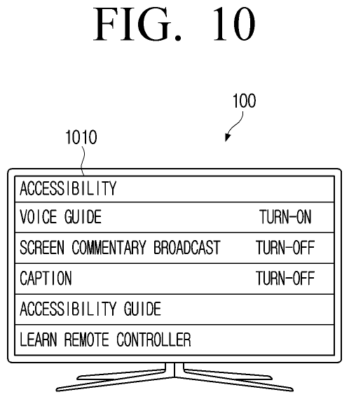

According to an example, the processor 120 may display, based on a user input being received while the second image 22 is selected through the GUI, a specific menu on the display 110. For example, the remote control device may transmit, when a menu button of the remote control device is selected by the user, a control command for displaying a menu to the display device 100. In this case, the processor 120 may display, based on the control command being received through the communication interface 150, the specific menu on the display 110. For example, the processor 120 may display, when a user input for displaying the menu is received in a normal situation (including when the first image 21 is selected through the GUI), a full menu screen on the display 110, but may display the specific menu when the second image 22 is selected through the GUI. For example, as illustrated in FIG. 10, the specific menu may include a menu 1010 (e.g., an accessibility menu) for setting a voice guide, a screen commentary, captions, and the like for users with an impairment to more easily use the display device 100.

According to an example, the processor 120 may transmit any one image from among the first image 21 and the second image 22 to an external device. For example, the processor 120 may transmit, based on receiving a user input for transmitting any one image from among the first image 21 and the second image 22 to the external device, the image selected according to the user input to the external device through the communication interface 150. The external device may be a device that is communicable with the display device 100 such as a user terminal (e.g., smartphone, tablet, etc.) and other display devices (e.g., TV, etc.) and includes a display function.

For example, the processor 120 may transmit, when a user input for selecting one image from among the first image 21 and the second image 22 is received while the first image 21 and the second image 22 are displayed on the display 110, the selected image to the external device.

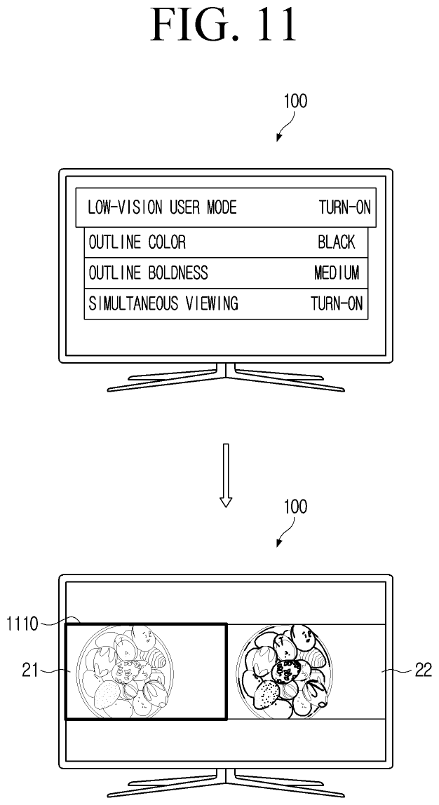

For example, the processor 120 may display, when a user input for turning-on the simultaneous viewing function is received, the first image 21 and the second image 22 on the display 110. In addition, as illustrated in FIG. 11, the processor 120 may display a GUI 1110 for selecting an image to be transmitted to the external device from among the first image 21 and the second image 22 on the display 110. In FIG. 11, although an edge portion of an image is shown as displayed in a different color, the above is not limited to this example. For example, the processor 120 may display a GUI using various methods such as displaying the outline portion of the image in a different color, displaying by highlighting the image, adding specific images such as an arrow, a cursor, and an indicator, and the like. The GUI may be moved according to a user input. In addition, the processor 120 may transmit, when a user input for selecting an image at which the GUI 1110 is positioned from among the first image 21 and the second image 22 is received, the image at which the GUI 1110 is positioned to the external device.

The processor 120 may display the image transmitted to the external device from among the first image 21 and the second image 22 and the remaining image on the display 110 using various methods.

According to an example, the processor 120 may display, when any one image from among the first image 21 and the second image 22 is transmitted to the external device, the remaining one image from among the first image 21 and the second image 22 in a main screen of the PIP screen, and control the display 110 to display the image transmitted to the external device in a sub screen of the PIP screen. The main screen may refer, for example, to a screen displayed on the display in full screen, and the sub screen may refer, for example, to a screen displayed by being overlayed at a portion of a region on the main screen.

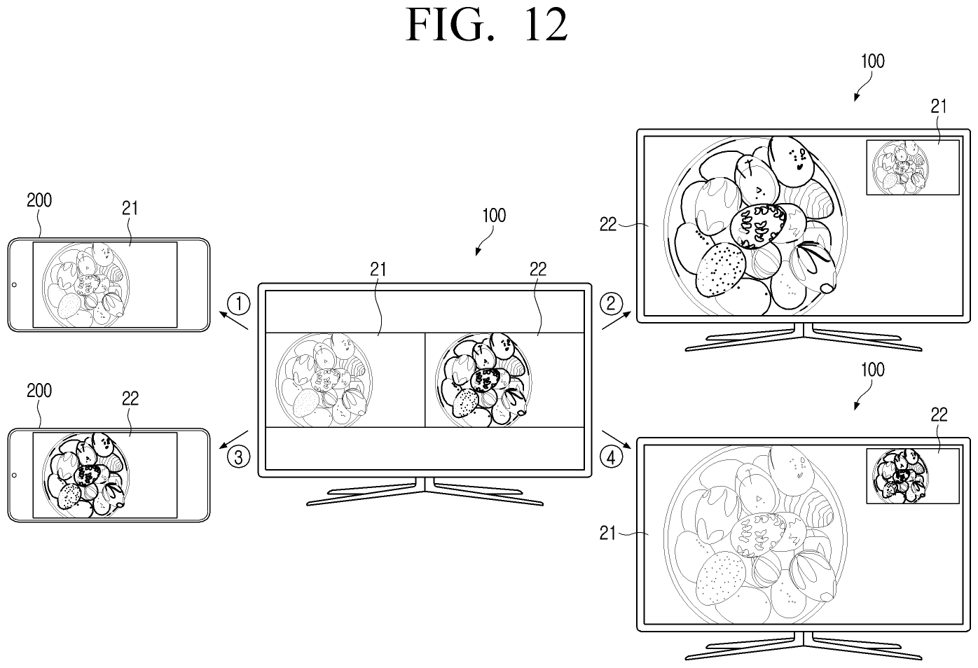

For example, as illustrated in FIG. 12, the processor 120 may transmit, when the first image 21 is selected according to a user input, the selected first image 21 to a user terminal 200 (\textcircled{1} of FIG. 12). The user terminal 200 may display the first image 21 received from the display device 100 (\textcircled{1} of FIG. 12). The processor 120 may display the second image 22 not transmitted to the user terminal 200 in the main screen of the PIP screen, and display the first image 21 transmitted to the user terminal 200 in the sub screen of the PIP screen (\textcircled{2} of FIG. 12).

In addition, as illustrated in FIG. 12, the processor 120 may transmit, when the second image 22 is selected according to a user input, the selected second image 22 to the user terminal 200 (\textcircled{3} of FIG. 12). The user terminal 200 may display the second image 22 received from the display device 100 (\textcircled{3} of FIG. 12). The processor 120 may display the first image 21 not transmitted to the user terminal 200 in the main screen of the PIP screen, and display the second image 22 transmitted to the user terminal 200 in the sub screen of the PIP screen (\textcircled{4} of FIG. 12).

According to an example, the processor 120 may control, when any one image from among the first image 21 and the second image 22 is transmitted to the external device, the display 110 for the remaining one image from among the first image 21 and the second image 22 to be displayed relatively larger than the image transmitted to the external device. The image being displayed relatively larger may include an image being displayed at a size larger than the previously displayed size. For example, it may be assumed that the first image 21 and the second image 22 are displayed in the same resolution according to simultaneous viewing. In this case, the screen ratio between the first image 21 and the second image 22 may be 1:1. The processor 120 may display, when any one image from among the first image 21 and the second image 22 is transmitted to the external device, the image transmitted to the external device at a resolution lower than before, and display the image not transmitted to the external device at a resolution higher than before. For example, the screen ratio between the first image 21 and the second image 22 which was displayed at the screen ratio of 1:1 may be changed to 1:2, 1:3, and the like. Accordingly, the image not transmitted to the external device may be displayed relatively larger than the image transmitted to the external device, and displayed larger than the size displayed before.

For example, it may be assumed that the display has a resolution of 7680×4320, and that the first image 21 and the second image 22 are displayed on the display 110 at resolutions of 3840×2160.

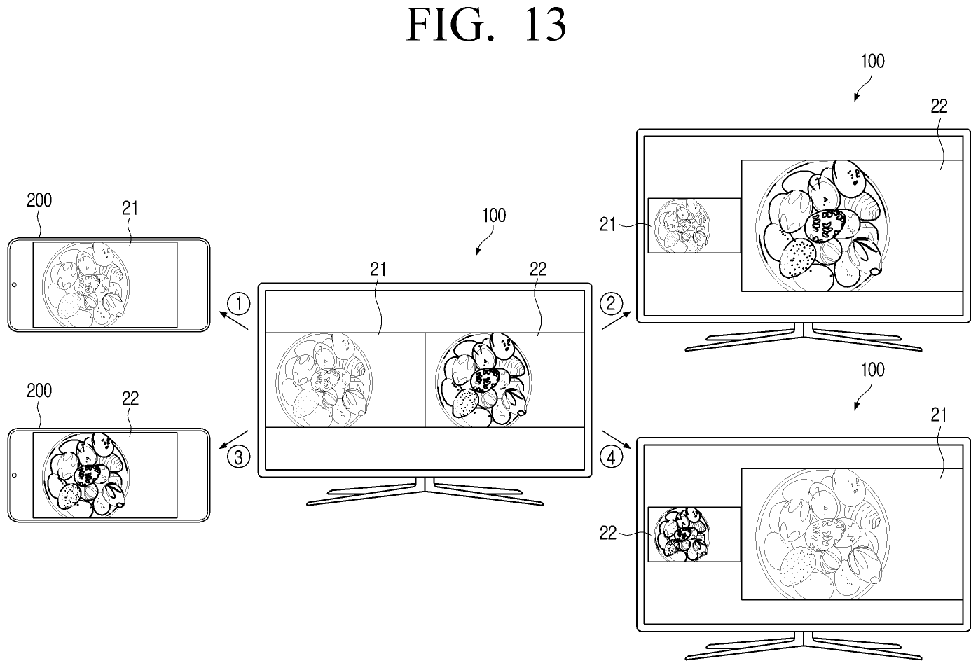

As illustrated in FIG. 13, the processor 120 may transmit, when the first image 21 is selected according to the user input, the selected first image 21 to the user terminal 200 (\textcircled{1} of FIG. 13). The user terminal 200 may display the first image 21 received from the display device 100 (\textcircled{1} of FIG. 13). The processor 120 may display the second image 22 not transmitted to the user terminal 200 larger than the first image 21 transmitted to the user terminal 220 (\textcircled{2} of FIG. 13). For example, the second image 22 having a resolution of 5120×2880 and the first image 21 having a resolution of 2560×1440 may be displayed on the display 110. Accordingly, the second image 22 may be displayed larger than the first image 21 before being transmitted to the user terminal 200.

In addition, as illustrated in FIG. 13, the processor 120 may transmit, when the second image 22 is selected according to the user input, the selected second image 22 to the user terminal 200 (\textcircled{3} of FIG. 13). The user terminal 200 may display the second image 22 received from the display device 100 (\textcircled{3} of FIG. 12). The processor 120 may display the first image 21 not transmitted to the user terminal 200 larger than the second image 22 transmitted to the user terminal 220 (\textcircled{4} of FIG. 13). For example, the first image 21 having a resolution of 5120×2880 and the second image 22 having a resolution of 2560×1440 may be displayed on the display 110. Accordingly, the first image 21 may be displayed larger than the second image 22 before being transmitted to the user terminal 200.

According to an example, the processor 120 may display, based on any one image from among the first image 21 and the second image 22 being transmitted to the external device, the remaining one image from among the first image 21 and the second image 22 in full screen of the display 110.

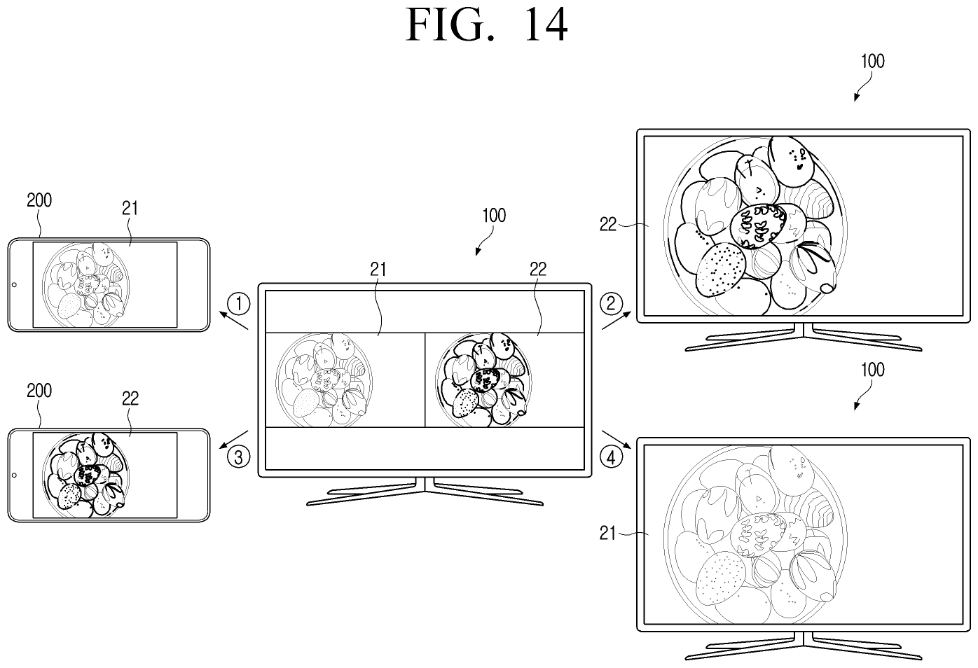

For example, as illustrated in FIG. 14, the processor 120 may transmit, when the first image 21 is selected according to the user input, the selected first image 21 to the user terminal 200 (\textcircled{1} of FIG. 14). The user terminal 200 may display the first image 21 received from the display device 100 (\textcircled{1} of FIG. 14). The processor 120 may display the second image 22 not transmitted to the user terminal 200 on the display 110 in full screen (\textcircled{2} of FIG. 14). The first image 21 transmitted to the user terminal 200 may not be displayed on the display 110.

In addition, as illustrated in FIG. 14, the processor 120 may transmit, when the second image 22 is selected according to the user input, the selected second image 22 to the user terminal 200 (\textcircled{3} of FIG. 14). The user terminal 200 may display the second image 22 received from the display device 100 (\textcircled{3} of FIG. 14). The processor 120 may display the first image 21 not transmitted to the user terminal 200 on the display 110 in full screen (\textcircled{4} of FIG. 14). The second image 22 transmitted to the user terminal 200 may not be displayed on the display 110.

As described above, when one image from among the first image 21 and the second image 22 is transmitted to the external device, the image not transmitted to the external device may be displayed larger than before, displayed in the main screen of the PIP screen, or displayed in full screen. For example, the user transmitting the image to the external device may be understood as intending to view the image viewed in the display device 100 in the external device. Accordingly, according to an example, if low-vision users continue to view the image through the display device 100, the visibility of the image for low-vision users may be increased and assist in the image viewing of low-vision users.

According to an example, the processor 120 may change a display mode of the display device 100 according to a user input. For example, the remote control device may transmit, when a specific button of the remote control device is selected by the user, a control command for changing the display mode to the display device 100. Accordingly, the processor 120 may change, when the control command for changing the display mode is received, the display mode of the display device 100. In another example, the processor 120 may change, when a user input for changing the display mode is received through the user interface 160, the display mode of the display device 100. The display mode may include a general viewing mode, a low-vision user mode, and a simultaneous viewing mode. The general viewing mode may be a mode for displaying an image for general users, the low-vision user mode may be a mode for displaying an image for low-vision users, and the simultaneous viewing mode may be a mode for displaying the image for general users and the image for low-vision users.

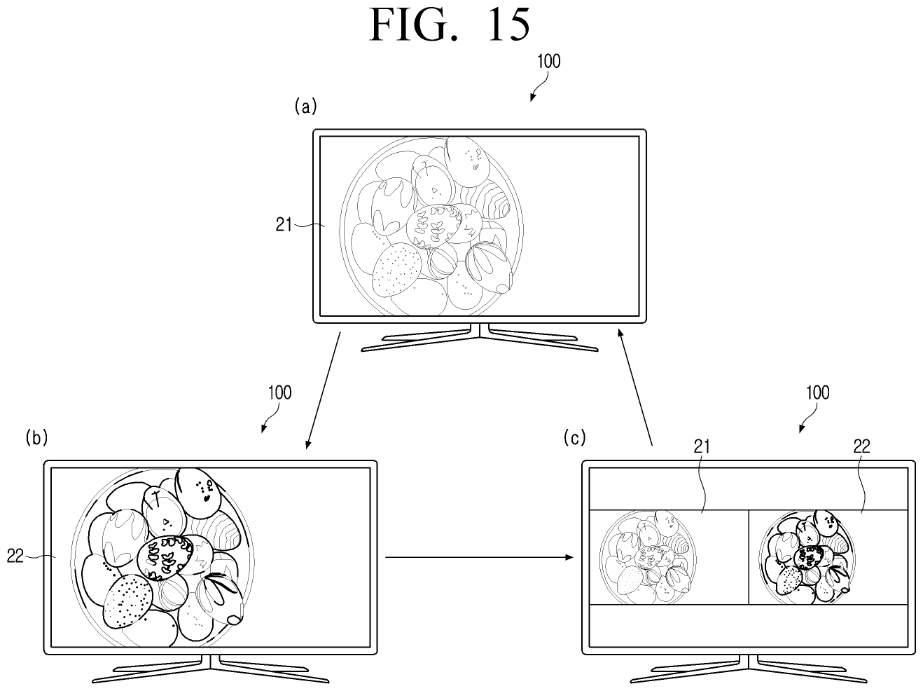

The processor 120 may display an image corresponding to the display mode of the display device 100 on the display 110. For example, as illustrated in FIG. 15, the processor 120 may display, when the display device 100 operates in the general viewing mode, the first image 21 in full screen of the display 110 ((a) of FIG. 15). Then, the processor 120 may change, when the user input for changing the display mode of the display device 100 is received, the display mode of the display device 100 from the general viewing mode to the low-vision user mode, and display the second image 22 in full screen of the display 110 ((b) of FIG. 15). The processor 120 may change, when the user input for changing the display mode of the display device 100 is received, the display mode of the display device 100 from the low-vision user mode to the simultaneous viewing mode, and display the first image 21 and the second image 22 on the display 110 ((c) of FIG. 15). The processor 120 may change, when the user input for changing the display mode of the display device 100 is received, the display mode of the display device 100 from the simultaneous viewing mode to the general viewing mode.

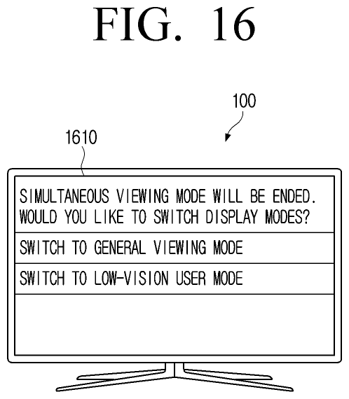

In the above-described example, the display mode has been described as being changed in an order according to the user input, but the above is not limited to this example. The processor 120 may control, when a user input for ending the simultaneous viewing mode is input while the display device 100 is operating in the simultaneous viewing mode, the display 110 for a menu for selecting the display mode of the display device 100 to be displayed. For example, as illustrated in FIG. 16, the menu may be a menu 1610 for selecting to which display mode to operate the display device 100 after the simultaneous viewing mode is ended. The processor 120 may end the simultaneous viewing mode when the user input for ending the simultaneous viewing mode is input, and switch the display mode of the display device 100 to a mode selected through the menu. For example, the processor 120 may change, when the general viewing mode is selected through the menu, the display mode of the display device 100 to the general viewing mode, and display the first image 21 on the display 110. The processor 120 may change, when the low-vision user mode is selected through the menu, the display mode of the display device 100 to the low-vision user mode, and display the second image 22 on the display 110.

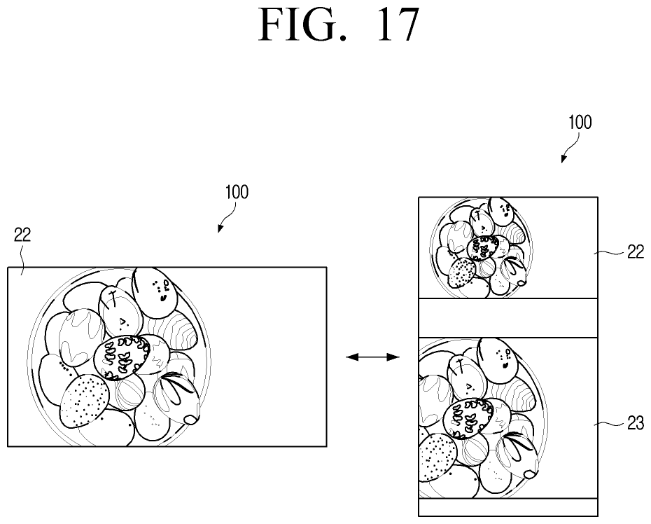

According to an example, the processor 120 may display the second image 22 on the display 110 while the display device 100 is operating in the horizontal mode. For example, as illustrated in FIG. 17, the processor 120 may display the second image 22 in full screen of the display 110 which is disposed in the horizontal direction according to the screen ratio of the display 110 disposed in the horizontal direction and the ratio of the second image 22.

The processor 120 may change, when the user input for changing the mode of the display device 100 is received, the mode of the display device 100 from the horizontal mode to the vertical mode. For example, the processor 120 may dispose the display 110 in the vertical direction by rotating the display 110 disposed in the horizontal direction, and display the second image 22 on the display 110. In the case of the horizontal mode and the vertical mode, in light of the screen ratios of the display 110 being different from one another, the second image 22 may be displayed at a portion of a region of the display 110 which is disposed in the vertical direction as in FIG. 17.

As illustrated in FIG. 17, the processor 120 may display a third image 23 with a portion of a region of the second image 22 enlarged at a remaining region of the display 110. For example, when the second image 22 is displayed at an upper region of the display 110 disposed in the vertical direction, the third image 23 may be displayed at a lower region of the display 110 disposed in the vertical direction. However, the above is not limited to this example, and the second image 22 may be displayed at the lower region, and the third image 23 may be displayed at the upper region. In addition, a portion of a region of the second image 22 that is enlarged may be a center region of the second image 22. The portion of the region of the second image 22 that is enlarged may be changed according to a user input. For example, the processor 120 may enlarge a region selected from the second image 22 according to the user input, and display the third image 23 including the enlarged region on the display 110.

According to an example, the display mode of the display device 100 may include a single-view mode and a multi-view mode. The single-view mode may be a mode for displaying one image provided from an input source, and the multi-view mode may be a mode for displaying different images provided from the same or different input sources together.

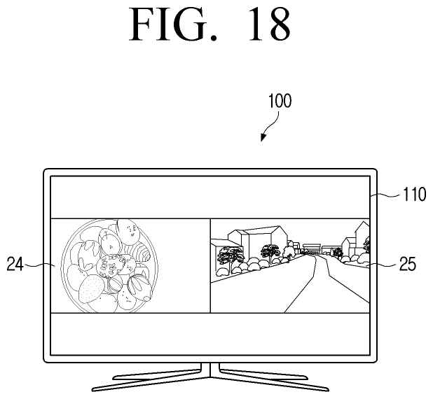

For example, the processor 120 may display, when a user input for selecting the multi-view mode is received through the menu, a plurality of images 24 and 25 on the display 110 as illustrated in FIG. 18.

The processor 120 may generate, when the low-vision user mode is selected while the display device 100 is operating in the multi-view mode, an image for low-vision users by processing one image from among the plurality of images 24 and 25, and display the generated image on the display 110.

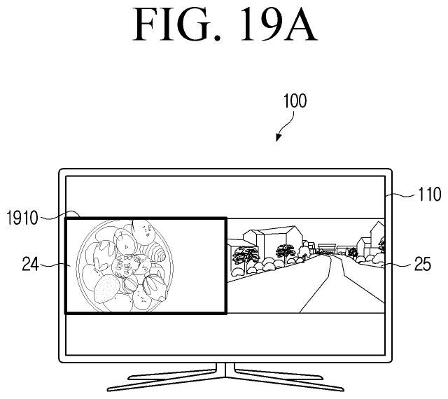

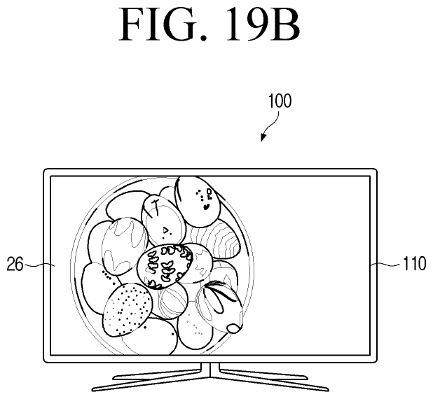

For example, as illustrated in FIG. 19A, the processor 120 may display, when the low-vision user mode is selected based on a user input while the display device 100 is operating in the multi-view mode, a GUI 1910 for selecting one from among the plurality of images 24 and 25 on the display 110. For example, the processor 120 may display the GUI using various methods such as displaying an edge portion of the image in a different color, displaying by highlighting the image, adding specific images such as an arrow, a cursor, and an indicator, and the like. The GUI may be moved according to a user input, and the image at which the GUI is positioned from among the plurality of images 24 and 25 may be selected.

The processor 120 may generate an image for low-vision users by processing the image selected according to the user input from among the plurality of images 24 and 25, and display the generated image on the display 110. For example, it may be assumed that an image 24 from among the plurality of images 24 and 25 is selected. The processor 120 may generate an image 26 for low-vision users by processing the image 24 through the main pipeline 2. As illustrated in FIG. 19B, the processor 120 may display the image 26 for low-vision users on the display in full screen.

According to an example, the processor 120 may generate, when the low-vision user mode and the simultaneous viewing function are activated while the display device 100 is operating in the multi-view mode, an image for low-vision users by processing one image from among the plurality of images displayed through the multi-view mode, and display the plurality of images and the image for low-vision users together on the display 110.

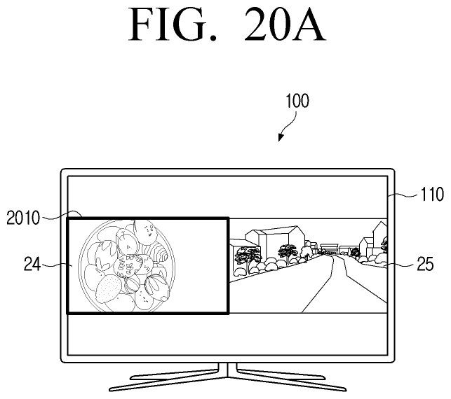

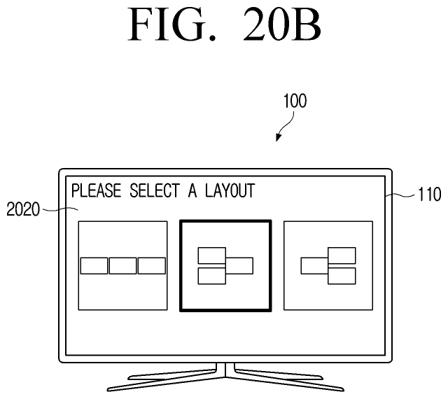

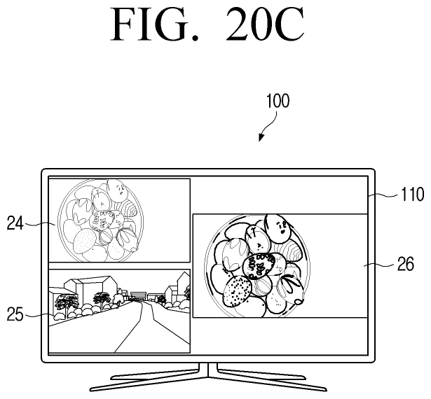

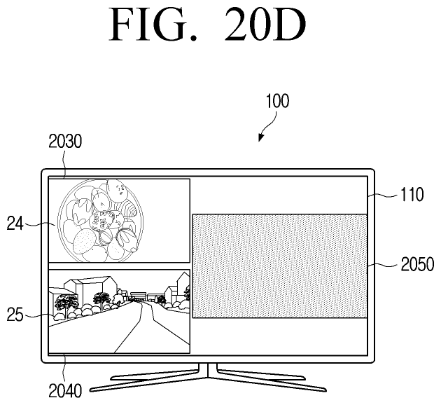

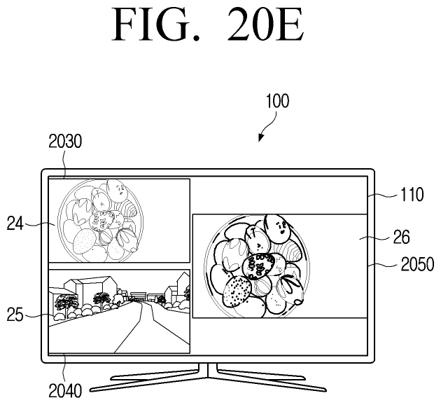

For example, as illustrated in FIG. 20A, the processor 120 may display, when the low-vision user mode and the simultaneous viewing function are activated based on a user input while the display device 100 is operating in the multi-view mode, a GUI 2010 for selecting one from among the plurality of images 24 and 25 on the display 110. For example, the processor 120 may display the GUI using various methods such as displaying the edge portion of the image in a different color, displaying by highlighting the image, adding specific images such as an arrow, a cursor, and an indicator, and the like. The GUI may be moved according to the user input, and the image at which the GUI is positioned from among the plurality of images 24 and 25 may be selected.

The processor 120 may generate an image for low-vision users by processing the image selected according to the user input from among the plurality of images 24 and 25. In addition, as illustrated in FIG. 20B, the processor 120 may display a menu 2020 for selecting a plurality of images and a layout in which an image is displayed for low-vision users on the display 110. As illustrated in FIG. 20C, the processor 120 may display, when the layout is selected according to a user input, the plurality of images 24 and 25 and the image 26 for low-vision users in the selected layout on the display 110.

In the above-described example, the menu for selecting a layout has been described as being displayed when the low-vision user mode and the simultaneous viewing function are activated while the display device 100 is operating in the multi-view mode, but the above is not limited to this example. For example, the processor 120 may display, when the user input for selecting the multi-view mode is received through the menu, the menu for selecting the layout on the display 110. The processor 120 may display, when the layout is selected according to the user input, the plurality of images 24 and 25 in the selected layout in the multi-view mode.

For example, as illustrated in FIG. 20D, the processor 120 may display, when a layout including three regions 2030, 2040, and 2050 is selected, the two images 24 and 25 which were displayed in the multi-view mode at two regions 2030 and 2040 from among the three regions 2030, 2040, and 2050. In this case, the region at which the image is displayed may be selected according to a user input. The processor 120 may generate, when the low-vision user mode and the simultaneous viewing function are activated, an image for low-vision users, and display the image for low-vision users at a region where the plurality of images is not being displayed according to the multi-view mode from among a plurality of regions. In this case, the region where the image for low-vision users is displayed from among the regions where the plurality of images are not displayed may be selected according to the user input. For example, as illustrated in FIG. 20E, the processor 120 may display the image 26 for low-vision users at a remaining region 2050 from among the three regions 2030, 2040, and 2050.

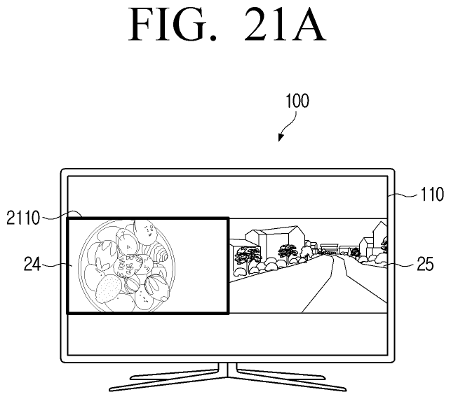

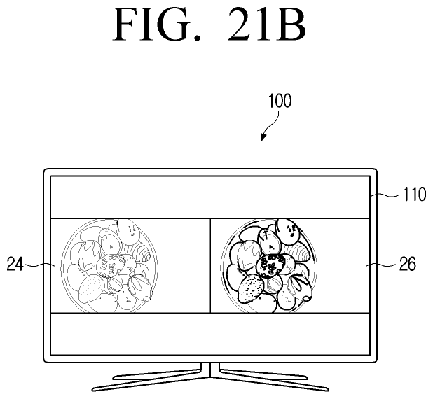

In the above-described example, the plurality of images and the image for low-vision users have been described as being displayed together on the display 110 according to the multi-view mode when the low-vision user mode and the simultaneous viewing function are activated while the display device 100 is operating in the multi-view mode, but the above is not limited to this example. For example, as illustrated in FIG. 21A, the processor 120 may display, when the low-vision user mode and the simultaneous viewing function are activated while the display device 100 is operating in the multi-view mode, a GUI 2110 for selecting one from among the plurality of images 24 and 25 on the display 110. The processor 120 may generate an image for low-vision users by processing the image selected through the GUI, and display the selected image and the image for the low-vision users together on the display 110. In this case, the display device 100 may not operate in the multi-view mode. For example, it may be assumed that the image 24 from among the plurality of images 24 and 25 is selected. In this case, as illustrated in FIG. 21B, the processor 120 may generate the image 26 for low-vision users by processing the selected image 24, and display the selected image 24 and the image 26 for low-vision users on the display 110. In FIG. 21B, the images 24 and 26 have been shown as being displayed at a screen ratio of 1:1, but the above is not limited to this example. For example, the screen ratio between the image 24 and the image 26 may be 1:1, 1:2, 1:3, and the like.

According to an example, the processor 120 may generate, when the low-vision user mode and the simultaneous viewing function are activated while the display device 100 is operating in the multi-view mode, an image for low-vision users by processing one image from among the plurality of images, and transmit the generated image to the external device. For example, when a user input for transmitting, to the external device, any one image from among the plurality of images 24 and 25 displayed on the display 110 according to the multi-view mode is received, the processor 120 may transmit the image selected according to the user input to the external device through the communication interface 150. The external device may be a device that is communicable with the display device 100 such as the user terminal (e.g., smartphone, tablet, etc.) and other display devices (e.g., TV, etc.) and includes the display function.

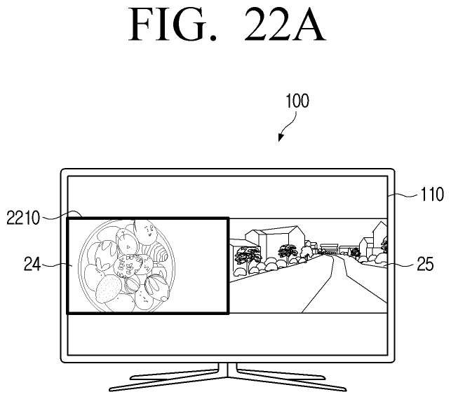

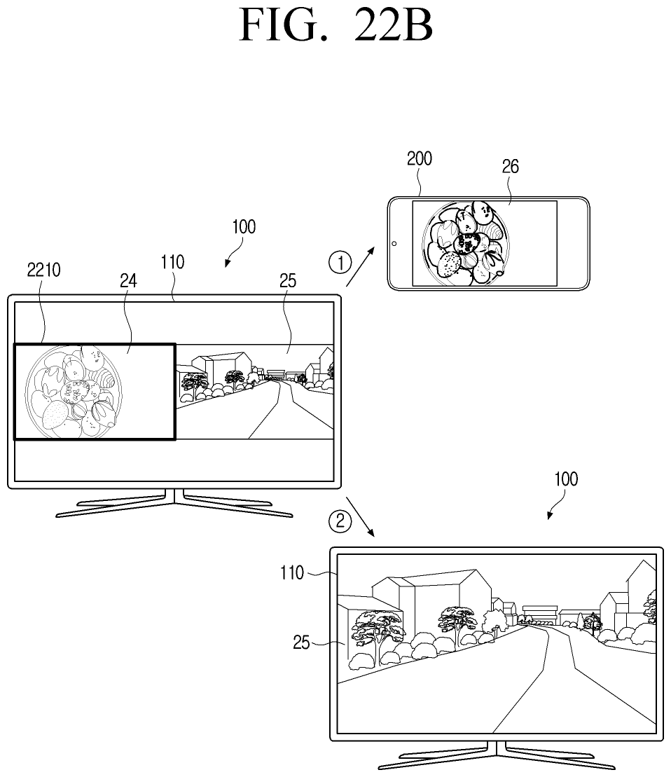

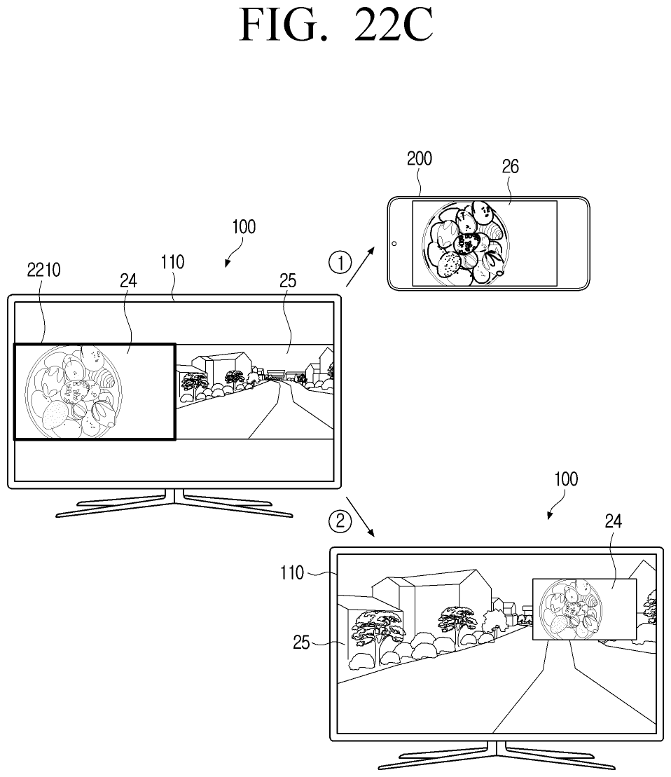

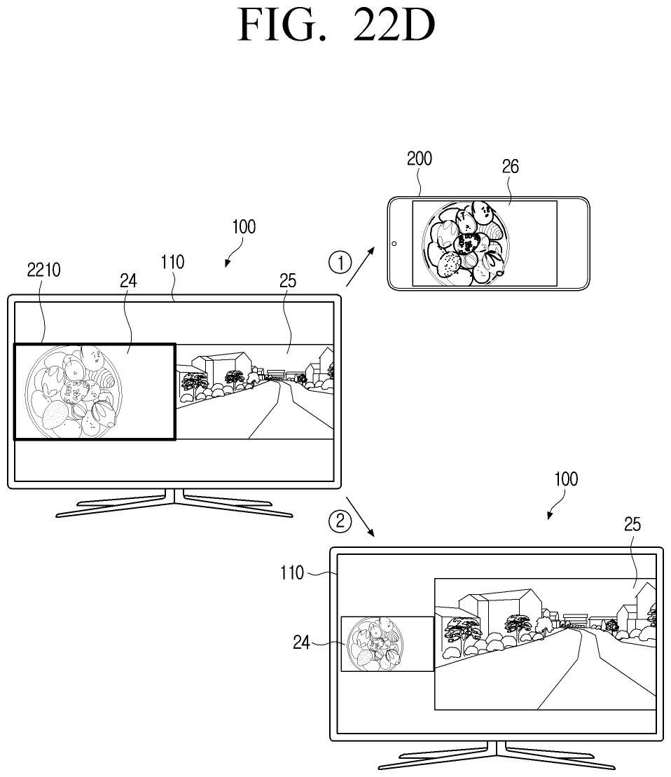

The processor 120 may generate, when a user input for selecting one image from among the plurality of images 24 and 25 is received while the plurality of images 24 and 25 is displayed on the display 110, an image for low-vision users by processing the selected image, and transmit the generated image to the external device. For example, as illustrated in FIG. 22A, the processor 120 may display a GUI 2210 for selecting an image to be transmitted to the external device from among the plurality of images 24 and 25 on the display 110. In FIG. 22A, although the edge portion of the image is shown as being displayed in a different color, the above is not limited to this example. For example, the processor 120 may display the GUI using various methods such as displaying by highlighting the image, adding specific images such as an arrow, a cursor, and an indicator, and the like. The GUI may be moved according to the user input. The processor 120 may generate, when a user input for selecting an image at which the GUI 2210 is positioned from among the plurality of images 24 and 25 is received, an image for low-vision users by processing the image at which the GUI 2210 is positioned, and transmit the generated image to the external device.

The processor 120 may display the image transmitted to the external device from among the plurality of images 24 and 25 and the remaining image on the display 110 using various methods.

According to an example, the processor 120 may display, when the image for low-vision users generated based on any one from among the plurality of images 24 and 25 is transmitted to the external device, the remaining image from among the plurality of images 24 and 25 on the display in full screen. For example, the processor 120 may change the display mode of the display device 100 from the multi-view mode to the single-view mode, and display the remaining image on the display 110 in full screen. The single-view mode may be a mode for displaying one image in full screen of the display 110

For example, as illustrated in FIG. 22B, the processor 120 may generate, when the image 24 is selected according to the user input, the image 26 for low-vision users by processing the selected image 24, and transmit the generated image 26 to the user terminal 200 (\textcircled{1} of FIG. 22B). The user terminal 200 may display the image 26 received from the display device 100 (\textcircled{1} of FIG. 22B). The processor 120 may display the image 25 not transmitted to the user terminal 200 on the display 110 in full screen (\textcircled{2} of FIG. 22B). The first image 21 transmitted to the user terminal 200 may not be displayed on the display 110.

According to an example, the processor 120 may generate an image for low-vision users based on the selected image from among the plurality of images 24 and 25. The processor 120 may display, when the image for the low-vision users is transmitted to the external device, the remaining image from among the plurality of images 24 and 25 in the main screen of the PIP screen, and control the display 110 to display the selected image in the sub screen of the PIP screen.

For example, as illustrated in FIG. 22C, the processor 120 may generate, when the image 24 is selected according to the user input, the image 26 for low-vision users by processing the selected image 24, and transmit the generated image 26 to the user terminal 200 (\textcircled{1} of FIG. 22C). The user terminal 200 may display the image 26 received from the display device 100 (\textcircled{1} of FIG. 22C). The processor 120 may display the image 25 not transmitted to the user terminal 200 in the main screen of the PIP screen, and display the image 24 selected according to the user input in the sub screen of the PIP screen (\textcircled{2} of FIG. 22C).

According to an example, the processor 120 may generate an image for low-vision users based on the selected image from among plurality of images 24 and 25. The processor 120 may control, when the image for low-vision users is transmitted to the external device, the display 110 for the remaining one image from among the plurality of images 24 and 25 to be displayed relatively larger than the selected image. The image being displayed relatively larger may include an image being displayed at a size larger than the previously displayed size. For example, it may be assumed that the plurality of images 24 and 25 is displayed in the same resolution according to multi-viewing. In this case, the screen ratio between the image 24 and the image 25 may be 1:1. The processor 120 may display, when the image for low-vision users is transmitted to the external device, the selected image at a resolution lower than before, and display the remaining image at a resolution higher than before. For example, the screen ratio between the image 24 and the image 25 which was displayed at the screen ratio of 1:1 may be changed to 1:2, 1:3, and the like. Accordingly, the remaining image may be displayed relatively larger than the selected image, and displayed larger than the size displayed before.

For example, as illustrated in FIG. 22D, the processor 120 may generate, when the image 24 is selected according to the user input, the image 26 for low-vision users by processing the selected image 24, and transmit the generated image 26 to the user terminal 200 (\textcircled{1} of FIG. 22D). The user terminal 200 may display the image 26 received from the display device 100 (\textcircled{1} of FIG. 22D). The processor 120 may display the image 25 which was not selected larger than the selected image 24 (\textcircled{2} of FIG. 22D). For example, the image 25 having a resolution of 5120×2880 and the image 24 having a resolution of 2560×1440 may be displayed on the display 110. Accordingly, the image 25 may be displayed larger than the image 24 before being transmitted to the user terminal 200.

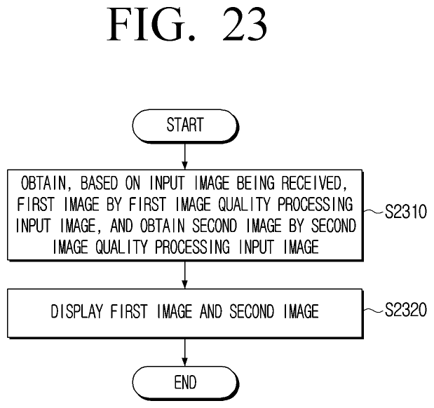

FIG. 23 is a flowchart illustrating an example image display method of a display device according to various embodiments.

When the input image is received, the first image may be obtained by first image quality processing the input image, and the second image may be obtained by second image quality processing the input image (S2310). The second image quality processing may include at least one from among the flattening process with respect to the input image and the outline process for emphasizing the outlines of the objects included in the input image.

The first image and the second image may be displayed (S2320).

In addition, in operation S2320, the resolutions of the first image and the second image may be identified based on the boldness of the outlines, and the first image and the second image may be displayed based on the identified resolutions of the first image and the second image.

In addition, in operation S2320, the screen ratio corresponding to the boldness of the outlines may be identified from among the plurality of screen ratios corresponding to the boldness of the plurality of outlines, and the first image and the second image may be displayed based on the identified screen ratio. The second image may have a relatively higher resolution than the first image in the screen ratio corresponding to the boldness of the outlines as the boldness of outline is higher.

In addition, the boldness of the outlines may be set based on the user input, or set based on the distance between the user in a relatively close distance with the display device from among the plurality of users and the display device.

In operation S2320, the distance between each of the plurality of users and the display device included in the image captured through the camera of the display device may be identified, the left and right positional relationship of the user positioned at a relatively close distance with the display device from among the plurality of users and the remaining user may be identified, and the first image and the second image may be displayed for the left and right positional relationship of the first image and the second image to correspond to the left and right positional relationship between users. The first image may be displayed at the position corresponding to the remaining user, and the second image may be displayed at the position corresponding to the user positioned at a relatively close distance with the display device.

In operation S2320, after the plurality of users is identified from the image captured through the camera of the display device, whether any one user from among the plurality of users has moved away from the viewing position may be identified based on the captured image, and if any one user from among the plurality of users has been identified as having moved away from the viewing position, the image corresponding to the remaining user maintaining the viewing position from among the first image and the second image may be displayed in full screen.

The image display method according to an example may further include displaying the GUI for selecting one from among the first image and the second image, and outputting, when the second image is selected through the GUI according to the user input, the screen commentary audio for the second image through the speaker of the display device.

In operation S2320, when any one from among the first image and the second image is transmitted to the external device, the remaining one image from among the first image and the second image may be displayed in the main screen of the PIP screen, and the image transmitted to the external device may be displayed in the sub screen of the PIP screen.

In operation S2320, when any one image from among the first image and the second image is transmitted to the external device, the remaining one image from among the first image and the second image may be displayed relatively larger than the image transmitted to the external device.

According to an embodiment of the disclosure, the various embodiments described above may be implemented with software including instructions stored in a machine-readable storage media (e.g., computer). The machine may call an instruction stored in a storage medium, and as a device operable according to the called instruction, may include an electronic device (e.g., electronic device (A)) according to the above-mentioned embodiments. Based on a command being executed by the processor, the processor may directly or using other elements under the control of the processor perform a function corresponding to the command. The command may include a code generated by a compiler or executed by an interpreter. A machine-readable storage medium may be provided in a form of a non-transitory storage medium. Herein, a ‘non-transitory’ storage medium is tangible and may not include a signal, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in a form of the machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or a memory of a relay server, or temporarily generated.

In addition, according to an embodiment of the disclosure, the various embodiments described above may be implemented in a recordable medium which is readable by a computer or a device similar to the computer using software, hardware, or the combination of software and hardware. In some cases, embodiments described herein may be implemented by the processor itself. According to a software implementation, embodiments such as the procedures and functions described herein may be implemented as separate software. The respective software may perform one or more functions and operations described herein.

The computer instructions for performing processing operations in a device according to the various embodiments described above may be stored in a non-transitory computer-readable medium. The computer instructions stored in this non-transitory computer-readable medium may cause a specific device to perform a processing operation of a device according to the above-described various embodiments when executed by at least one processor of the specific device. The non-transitory computer-readable medium may refer to a medium that stores data semi-permanently rather than storing data for a very short time, such as a register, a cache, a memory, or the like, and is readable by a device. Examples of the non-transitory computer-readable medium may include, for example, and without limitation, a compact disc (CD), a digital versatile disc (DVD), a hard disc, a Blu-ray disc, a USB, a memory card, a ROM, and the like.

In addition, respective elements (e.g., a module or a program) according to the various embodiments described above may be configured as a single entity or a plurality of entities, and a portion of sub-elements of the above-mentioned sub-elements may be omitted, or other sub-elements may be further included in the various embodiments. Alternatively or additionally, a portion of elements (e.g., modules or programs) may be integrated into one entity to perform the same or similar functions performed by the respective corresponding elements prior to integration. Operations performed by a module, a program, or other element, in accordance with the various embodiments, may be executed sequentially, in parallel, repetitively, or in a heuristically manner, or at least some operations may be performed in a different order, omitted, or a different operation may be added.

While the disclosure has been illustrated and described with reference to various example embodiments thereof, it will be understood that the various example embodiments are intended to be illustrative, not limiting. It will be understood by those skilled in the art that various changes in form and detail may be made therein without departing from the true spirit and full scope of the disclosure, including the appended claims and their equivalents. It will also be understood that any of the embodiment(s) described herein may be used in conjunction with any other embodiment(s) described herein.

What is claimed is:

1. A display device, comprising:
a display; and
at least one processor, comprising processing circuitry, individually and/or collectively, configured to control the display device to:
obtain, based on an input image being received, a first image by first image quality processing the input image, and obtain a second image by second image quality processing the input image, and
display the first image and the second image, and
wherein the second image quality processing comprises at least one from among a flattening process with respect to the input image and an outline process for emphasizing outlines of an object comprised in the input image.

2. The display device of claim 1,
wherein at least one processor, individually and/or collectively, is configured to:
identify resolutions of the first image and the second image based on boldness of the outlines, and control the display to display the first image and the second image based on the identified resolutions of the first image and the second image.

3. The display device of claim 2,
wherein at least one processor, individually and/or collectively, is configured to:
identify a screen ratio corresponding to the boldness of the outlines from among a plurality of screen ratios that correspond to boldness of a plurality of outlines, and display the first image and the second image in the display based on the identified screen ratios, and
wherein the second image has a higher resolution than the first image in a screen ratio corresponding to the boldness of the outlines as the boldness of the outlines is higher.

4. The display device of claim 2,
wherein the boldness of the outlines is set based on an input, or set based on a distance between a user in a relatively close distance with the display device from among a plurality of users and the display device.

5. The display device of claim 1, further comprising:
a camera;
wherein at least one processor, individually and/or collectively, is configured to:
identify a distance between each of a plurality of users included in an image captured through the camera and the display device,
identify a left and right positional relationship of a user positioned in a relatively close distance with the display device from among the plurality of users with the remaining users, and
control the display to display the first image and the second image for the left and right positional relationship of the first image and the second image to correspond to the left and right positional relationship between the users, and
wherein the first image is displayed at a position corresponding to the remaining users, and
the second image is displayed at a position corresponding to the user positioned in a relatively close distance with the display device among the plurality of users.

6. The display device of claim 1, further comprising:
a camera;
wherein at least one processor, individually and/or collectively, is configured to:
identify, based on a plurality of users being identified from an image captured through the camera, whether any one user from among the plurality of users has moved away from a viewing position based on the captured image, and
control, based on any one user from among the plurality of users being identified as having moved away from the viewing position, the display for an image corresponding to the remaining users maintaining the viewing position from among the first image and the second image to be displayed in full screen.

7. The display device of claim 1, further comprising:
a speaker;
wherein at least one processor, individually and/or collectively, is configured to:
control the display to display a graphical user interface (GUI) for selecting one from among the first image and the second image, and
output, based on the second image being selected through the GUI according to an input, a screen commentary audio for the second image through the speaker.

8. The display device of claim 1,
wherein at least one processor, individually and/or collectively, is configured to:
control the display to display, based on any one image from among the first image and the second image being transmitted to an external device, the remaining one image from among the first image and the second image in a main screen of a picture in picture (PIP) screen, and control the display for an image transmitted to the external device to be displayed in a sub screen of the PIP screen.

9. The display device of claim 1,
wherein at least one processor, individually and/or collectively, is configured to:
control, based on any one image from among the first image and the second image being transmitted to an external device, the display for the remaining one image from among the first image and the second image to be displayed relatively greater than an image transmitted to the external device.

10. A method displaying an image of a display device, the method comprising:
obtaining, based on an input image being received, a first image by first image quality processing the input image, and obtaining a second image by second image quality processing the input image; and
displaying the first image and the second image,
wherein the second image quality processing comprises at least one from among a flattening process with respect to the input image and an outline process for emphasizing the outlines of an object comprised in the input image.

11. The method of claim 10,
wherein the displaying comprises:
identifying resolutions of the first image and the second image based on boldness of the outlines, and displaying the first image and the second image based on the identified resolutions of the first image and the second image.

12. The method of claim 11,
wherein the displaying comprises:
identifying a screen ratio corresponding to the boldness of the outlines from among a plurality of screen ratios that correspond to boldness of a plurality of outlines, and displaying the first image and the second image based on the identified screen ratio, and
wherein the second image has a relatively higher resolution than the first image in a screen ratio corresponding to the boldness of the outlines as the boldness of outlines is higher.

13. The method of claim 11,
wherein the boldness of the outlines is set based on an input, or set based on a distance between a user in a relatively close distance with the display device from among a plurality of users and the display device.

14. The method of claim 10,
wherein the displaying comprises:
identifying a distance between each of a plurality of users included in an image captured through a camera of the display device and the display device;
identifying a left and right positional relationship of a user positioned in a relatively close distance with the display device from among the plurality of users and the remaining users; and
displaying the first image and the second image for a left and right positional relationship of the first image and the second image to correspond to the left and right positional relationship between users,
wherein the first image is displayed at a position corresponding to the remaining users, and
the second image is displayed at a position corresponding to the user positioned in a relatively close distance with the display device.

15. The method of claim 10,
wherein the displaying comprises:
identifying, based on a plurality of users being identified from an image captured through a camera of the display device, whether any one user from among the plurality of users has moved away from a viewing position based on the captured image; and
displaying, based on any one user from among the plurality of users being identified as having moved away from the viewing position, an image corresponding to the remaining users maintaining the viewing position from among the first image and the second image in full screen.

16. The method of claim 10, further comprising:
displaying a graphical user interface (GUI) for selecting one from among the first image and the second image, and
outputting, based on the second image being selected through the GUI according to an input, a screen commentary audio for the second image through a speaker of the display device.

17. The method of claim 10,
wherein the displaying comprises:
displaying, based on any one image from among the first image and the second image being transmitted to an external device, the remaining one image from among the first image and the second image in a main screen of a picture in picture (PIP) screen, displaying an image transmitted to the external device in a sub screen of the PIP screen.

18. The method of claim 10,
wherein the displaying comprises:
based on any one image from among the first image and the second image being transmitted to an external device, displaying the remaining one image from among the first image and the second image to be displayed relatively greater than an image transmitted to the external device.

19. A non-transitory computer readable recording medium storing computer instructions that cause an display device to perform an operation when executed by at least one processor of the display device, wherein the operation comprises;
obtaining, based on an input image being received, a first image by first image quality processing the input image, and obtaining a second image by second image quality processing the input image; and
displaying the first image and the second image,
wherein the second image quality processing comprises at least one from among a flattening process with respect to the input image and an outline process for emphasizing the outlines of an object comprised in the input image.

20. The medium of claim 19,
wherein the displaying comprises:
identifying resolutions of the first image and the second image based on boldness of the outlines, and displaying the first image and the second image based on the identified resolutions of the first image and the second image.
